(19) United States
(12) Patent Application Publication
(10) Pub. No.: US 2011/0064958 A1
(43) Pub. Date: Mar. 17, 2011

(54) WEATHER-RESISTANCE RESIN BASE MATERIAL AND OPTICAL ELEMENT

(75) Inventor: Tatsuya Hirose, Hachioji-shi (Tokyo) (JP)

(73) Assignee: KONICA MINOLTA HOLDINGS, INC., Tokyo (JP)

(21) Appl. No.: 12/934,920

(22) PCT Filed: Jun. 4, 2009
(86) PCT No.: PCT/JP2009/060251

§ 371 Date: Sep. 27, 2010

(30) Foreign Application Priority Data
Jun. 9, 2008 (JP) 2008-150296

(51) Int. Cl. B32B 27/36; B32B 27/06

(52) U.S. Cl. 428/446; 428/702; 428/698; 428/480

(57) ABSTRACT

Provided are a weather-resistant resin base material and an optical member having satisfactory weather resistance even when affected by heat, light and moisture. The weather-resistant resin base material has on at least one side of a resin base material which contains a light-stabilizer at least one ceramic layer having, as the main component, oxide, oxynitride or nitride containing Si or Al, and the steam permeability (JIS K7129-1992, method B, under conditions of 40° C. and 90% RH) is not more than 0.01 g/(m²·24 h).

### TECHNICAL FIELD

The present invention relates to weather resistance resin base materials used mainly for the purpose of enhancing weather resistance and optical elements, as overlay films used for the purpose of surface protection, gloss enhancement and discoloration and deterioration prevention for a marking film used by being pasted on the surface of railway vehicles, cars, automatic vending machines and the like; a surface protective film of an exterior signboard; an antireflection film of a liquid crystal display, a backseat for a solar battery; a film for an electronic paper sheet; an electromagnetic wave shielding film for a plasma display, a film for organic electroluminescence; a base material of a film to be pasted on a window, such as a heat ray reflecting film which is pasted on windows of facilities exposed to sunlight for a long time, such as outdoor windows of building and car windows so as to provide a heat ray reflecting effect; a base material of a reflective board; a base material of a light collecting boar; a film for a vinyl house for agriculture; and the like.

### BACKGROUND ART

Usually, polymer film causes cleavage of molecular chains due to a photooxidation reaction by being irradiated with UV rays (Ultraviolet rays) under the existence of oxygen, thereby successively causing strength deterioration, haze rise-up, and transparency and color tone lowering due to yellow discoloration (UV ray deterioration). UV rays of sunlight have a wavelength of 295 to 400 nm, and the energy of the light in the above wavelength region is almost equal to the bonding energy of C, H, and O. Therefore, if a plastic molded product composed of mainly the bonding of C, H and O is irradiated with UV rays, there is fear that such a bonding may collapse to cause deterioration of resin, discoloration and lowering of mechanical strength. Accordingly, plastic molded products cannot be used in outdoor for a long period of time. For this reason, a conventional technique of improving the weather resistance of polymer film by blending a light stabilizer in the polymer film has been known well generally.

The light stabilizer is a stabilizer used for the purpose of inhibiting a photooxidation reaction of a polymer film due to the irradiation of UV rays, and as the light stabilizer, an ultraviolet absorber, quencher, and HALS (Hindered Amine Light Stabilizer) are well known.

The ultraviolet absorber is a light stabilizer which absorbs UV rays and discharges energy absorbed in its molecular by converting the energy into a low energy in the form of heat, phosphorescence, or fluorescence, and as the ultraviolet absorber, a benzophenone type, a benzotriazol type, a benzoate type, a cyanoacrylate type, and the like are put in practical use.

The quencher is a light stabilizer in which chromophoric groups (mainly unsaturated hydrocarbons and their compounds) being on a ground state absorb UV rays so as to return groups being an excited state to the original ground state, and as the quencher, Ni compounds are employed.

The HALS is a light stabilizer which traps an alkyl radical, a peroxy radical and the like that are produced by the radiation of UV rays, thereby inhibiting a photooxidation reaction, and the HALS is a compound having a hindered piperidine skeleton.

However, even if a light stabilizer, such as an ultraviolet absorber, is made to be contained in a polymer film, the influence of UV rays on its surface is not sufficiently eliminated so that deterioration on the surface of the polymer film cannot be suppressed. Further, in order to obtain the weather resistance sufficiently, it is necessary to make a polymer film to contain a sufficient amount of a light stabilizer. However, if the polymer film is exposed to an environment with heat and water, bleed out, sublimation, and the like take place on the polymer film. Accordingly, the polymer film loses the light stabilizer, resulting in lowering of weather resistance, lowering of transparency, and rising-up of haze. Since a light stabilizer is expensive, a sufficient amount of a light stabilizer causes a large cost hike.

Further, as another method of enhancing weather resistance, a method of coating a UV ray absorbing material is a dominant method. However, since the surface of the coating film is exposed to rain water, oxygen in atmosphere and pollution substance, the coating film deteriorates and the resultant back effects, such as discoloration due to yellowish color change, lowering of transmittance and raising-up of haze become large problems.

Furthermore, as another method of enhancing weather resistance, generally, when a coating film of an acrylic resin being excellent in weather resistance is formed, the coating film may be effective to enhance weather resistance. However, if the coating film of an acrylic resin is actually used in outdoors for a long period of time, deterioration of the acrylic resin is observed so that weather resistance is not sufficient.

Further, a structure in which AR is provided on a base material in which a light stabilizer is mixed into, is disclosed. In this structure, the surface is made of inorganic materials and weather resistance is relatively high. However, bather properties are not sufficient. Therefore, if the structure is exposed to wind and rain, or if water droplets due to dew condensation by a dew point deposit on the surface of the structure, an oxidizing source permeates gradually in the structure, and eventually reaches the base material so that a sufficient oxidizing source is provided to the base material. As a result, the structure does not obtain weather resistance sufficiently.

### PRIOR ART DOCUMENT

### Patent Document

Patent documents 1: Japanese Unexamined Patent Publication No. 2005-153441

Patent documents 2: Japanese Unexamined Patent Publication No. 2005-15557

Patent documents 3: Japanese Unexamined Patent Publication No. 2001-315262

### Problems to be Solved by the Invention

The present invention has been achieved in view of the above-mentioned problems, and an object of the present invention is to provide a weather resistance resin base material and optical element which have sufficient weather resistance even if receiving influences by light and moisture.

### Means for Solving the Problems

The above-mentioned object of the present invention is attained by the following structures.

1. A weather resistance resin base material is characterized in that the weather resistance resin base material comprises at least one layer of a ceramic layer composed of an oxide containing Si or Al, a nitrogen oxide or a nitride as a main component. on at least one side of a resin base material containing a light stabilizer, wherein a moisture vapor transmission rate (JIS K7129-1992 B method, under the condition of 40° C., and 90% RH) is 0.01 g/(m²·24 h) or less.
2. The weather resistance resin base material described in the above 1 is characterized in that the resin of the resin base material is polyethylene terephthalate, polybutylene terephthalate, or polyethylene naphthalate.
3. The weather resistance resin base material described in the above 1 or 2 is characterized in that the light stabilizer is a ultraviolet absorber, a hindered amine light stabilizer or a ultraviolet absorber and a hindered amine light stabilizer.
4. The weather resistance resin base material described in any one of the above 1 to 3 is characterized in that the above ceramic layer is formed by a thin film forming method which feeds a gas containing a thin film forming gas and a discharge gas in a discharge space under an atmospheric pressure or a pressure in the vicinity of the atmospheric pressure; applies a high frequency electric field in the discharge space so as to excite the gas; and exposes to the excited gas so as to form a thin film.
5. The weather resistance resin base material described in the above 4 is characterized in that the discharge gas is a nitrogen gas; a first high frequency electric field and a second high frequency electric field are superimposed in the high frequency electric field applied in the discharge space; a frequency ω2 of the second high frequency electric field is higher than a frequency ω1 of the first high frequency electric field; a relation among the intensity V1 of the first high frequency electric field, the intensity V2 of the second high frequency electric field, and the intensity IV of a discharge starting electric field satisfies a relationship of (V1≧IV>V2 or V1>IV≧V2); and the output density of the second high frequency electric field is 1 W/cm² or more.
6. The weather resistance resin base material described in any one of the above 1 to 5 is characterized in that the refractive index of the ceramic layer is 1.3 or more and less than 1.8.
7. The weather resistance resin base material described in any one of the above 4 to 6 is characterized in that the ceramic layer comprises at least one layer or more of each of a silicon oxide layer having a carbon content less than 0.1 at % and a silicon oxide layer having a carbon content of 1 to 40 at %.
8. The weather resistance resin base material described in any one of the above 1 to 7 is characterized in that a polymer layer is provided on at least one side surface of the resin base material and a ceramic layer is provided on the polymer layer.
9. The weather resistance resin base material described in any one of the above 1 to 8 is characterized in that a polymer layer is provided on the ceramic layer.
10. The weather resistance resin base material described in the above 9 is characterized in that the polymer layer contains a light stabilizer.
11. An optical member is characterized by employing the weather resistance resin base material described in any one of the above 1 to 10.

### EFFECT OF THE INVENTION

According to the invention, it becomes possible to provide a weather resistance resin base material and an optical member which have sufficient weather resistance even if receiving the influence of heat, light, and moisture.

### BRIEF DESCRIPTION OF THE DRAWINGS

FIG. 1 is a cross section structural view showing a structure of a weather resistance resin base material.

FIG. 2 is an outline view showing an example of a jet type atmospheric plasma discharge processing apparatus.

FIG. 3 is an outline view showing an example of an atmospheric plasma discharge processing apparatus with a type to process a base material between paired electrodes.

FIG. 4 is a perspective view showing an example of a structure of a roll-shaped rotating electrode including a conductive metal base material and a derivative covered on the base material.

FIG. 5 is a perspective view showing an example of a structure of a square tube type electrode including a conductive metal base material and a derivative covered on the base material.

### BEST MODE FOR CARRYING OUT THE INVENTION

As a result of having conducted studies earnestly in view of the above problems, the inventor found that with a weather resistance resin base material which comprises at least on layer of a ceramic layer composed of an oxide containing Si or Al, a nitrogen oxide containing Si or Al, or a nitride containing Si or Al as a main component on at least one side of a resin base material containing a light stabilizer, wherein a moisture vapor transmission rate (JIS K7129-1992 B method, under the condition of 40° C., and 90% RH) is 0.01 g/(m²·24 h); it becomes possible to obtain a weather resistance resin base material and optical element which have sufficient weather resistance even if receiving influences by light and moisture, whereby the inventor has achieved the invention.

In the present invention, a ceramic layer intercepts oxygen and moisture which are causes of deterioration, thereby preventing the deterioration of surfaces. Further, the light stabilizer (UV absorber and the like) in the resin base material prevents photooxidation by UV rays, and the provision of the ceramic layer suppresses the bleed out of the light stabilizer, whereby it seems that it becomes possible to obtain a weather resistance resin base material which does not cause deteriorations such as Yellowing (yellowish color change), deterioration of mechanical strength, raising-up of haze even if being used for a long period of time in outdoors.

Hereafter, the present invention will be explained in detail.

A weather resistance resin base material according to the invention is characterized in that the weather resistance resin base material comprises at least one layer of a ceramic layer composed of an oxide containing Si or Al, a nitrogen oxide containing Si or Al, or a nitride containing Si or Al as a main component on at least one side of a resin base material containing a light stabilizer, wherein a moisture vapor transmission rate (JIS K7129-1992 B method, under the condition of 40° C., and 90% RH) is 0.01 g/(m²·24 h).

### <<Resin Base Material>>

In the present invention, a resin base material means a resin film single body or a resin film the resin film in which an organic layers, such as a polymer layer, is laminated on one side or both sides of the resin film. In the weather resistance resin base material of the present invention, a ceramic layer later mentioned later is provided on at least one side of such a resin base material.

As far as the resin base material used in the invention is a resin film capable of holding the above organic layer or a ceramic layer, the resin base material is not restricted specifically.

Specifically, examples of resin constituting the resin base material include: polyolefine (PO) resins, such as homopolymers or copolymers of ethylene, polypropylene, and butene; amorphous polyolefin resins (APO), such as cyclic polyolefin; polyester resins, such as polyethylene terephthalate (PET), and polyethylene-2,6-naphthalate (PEN); polyimide (PA) resins; such as nylon 6, nylon 12, and copolymerized nylon; polyvinyl alcohol (PVA) resins; polyvinyl alcohol resins, such as ethylene-vinyl alcohol copolymer (EVOH); polyimide (PI) resins; polyetherimide (PEI) resins; polysulfone (PS) resins; polyether sulfone (PES) resins; polyether-ether-ketone (PEEK) resins; polycarbonate (PC) resins; polyvinyl butyrate (PVB) resins; polyarylate (PAR) resins; fluorine type resins, such as ethylene-tetrafluoride ethylenic copolymer (ETFE), ethylene chloride trifluoride (PFA), ethylene-tetrafluoride perfluoroalkyl vinyl ether copolymer (FEP), vinylidene fluoride (PVDF), vinyl fluoride (PVF), perfluoroethylene-perfluoropropylene-perfluorovinyl ether copolymer (EPA).

Further, in addition to the above resins, employable examples include: light hardening resins, such as a resin composition composed of an acrylate compound having a radical reactive unsaturated compound; a resin composition composed of the above acrylate compound and a mercapto compound having a thiol group; and a resin composition in which oligomers, such as epoxy acrylate, urethane acrylate, polyester acrylate, and polyether acrylate, are dissolved in a multifunctional acrylate monomer; and a mixture of the above resin compositions. Furthermore, a resin base material in which one kind or two or more kinds of the above resins are laminated by means of laminating, coating or the like can be also used as a resin film.

These materials may be employed solely or by being mixed appropriately. Among them, preferably usable are products on the market, such as ZEONEX and ZEONOR (manufactured by Zeon Corporation), ARTON being an amorphous cyclo polyolefin resin film (manufactured by JSR Corporation), PURE ACE being a polycarbonate film (manufactured by TEIJIN LIMITED), and KONICA TAC KC4UX, KC8UX being a cellulose triacetate film (manufactured by Konica Minolta Opt. Inc.).

Further, it is desirable that a resin film is transparent and has high light resistance and high weather resistance.

Furthermore, the abovementioned resin film may be an unstretched film or a stretched film.

The resin film according to the present invention can be produced by well-known general methods. For example, a resin used as materials is meld by an extruder, the melted resin is extruded from a ring die or a T die and is cooled, whereby a unstretched base material which is substantially amorphous and is not oriented, can be produced. Further, such an unstretched base material is stretched in the flow direction (longitudinal direction) of the base material or the direction (transverse direction) perpendicular to the flow direction by well-known methods, such as uniaxial stretching, tentar type serial biaxial stretching, tentar type simultaneous biaxial stretching, and tubular type simultaneous biaxial stretching, whereby a stretched base material can be produced. In this case, although a stretching magnification may be appropriately selected in accordance with the resin used as materials, the magnification may be preferably two to ten times in the longitudinal direction and in the transverse direction respectively.

Among the resins constituting the base material film, preferable examples include: aromatic polyesters represented by polyethylene terephthalate and polyethylene-2,6-naphthalate; aliphatic polyamide represented by nylon 6 and nylon 66; polyolefin represented by aromatic polyamide, polyethylene and polypropylene; polycarbonate; and the like. Among the above resins, more preferable examples include: aromatic polyester, polyethylene terephthalate and polyethylene-2,6-naphthalate; and particularly preferable examples include: polyethylene terephthalate, polybutylene terephthalate, and polyethylenenaphthalate.

The above-mentioned aromatic polyester may be made to contain suitable filler, if needed. As such filler, a well-know filler as a slipping property providing agent for a polyester film may be employed. Examples of filler include: calcium carbonate, calcium oxide, aluminium oxide, kaolin, silicon oxide, zinc oxide, carbon black, silicon carbide, tin oxide, cross-linked acrylic resin particles, cross-linked poly styrene resin particles, melamine resin particles, cross-linked silicon resin particle, etc. It is preferable that the slipping property providing agent has an average particle size of 0.01 to 10 μm and the content of the agent is 0.0001 to 5 mass % within an amount capable of maintaining the transparency of the film. Further, the aromatic polyester may be made to contain appropriately a colorant, an antistatic agent, an antioxidant, an organic lubricant, catalyst residue particles, etc.

Moreover, for the resin film according to the present invention, before a polymer layer, a ceramic layer, etc. are formed, surface treatments, such as corona treatment, flame treatment, plasma treatment, glow discharge treatment, surface roughening treatment, and chemical treatment, may be applied.

It may be convenient that the resin film is wound up to a rolled form as a long size product. The thickness of the resin film may be made preferably in a range of 10 to 400 μm, more preferably in a range of 30 to 200 μm.

### <<Light Stabilizer>>

The resin base material according to the present invention contains a light stabilizer. Further, a polymer layer mentioned later preferably contains a light stabilizer. More preferably, the resin base material and the polymer layer contain a light stabilizer respectively.

Examples of the light stabilizer employable in the present invention include: an ultraviolet absorber, a radical scavenger, an antioxidant, and the like. Employable examples of such a light stabilizer include: organic type light stabilizers, such as a hindered amine type, a salicylic acid type, a benzophenone type, a benzotriazol type, a cyanoacrylate type, a triazine type, a benzoate type, and an oxalic acid anilide type; and an inorganic type light stabilizers, such as sol-gel.

Specific examples of preferably employable light stabilizer include, without being limited thereto:

hindered amine type light stabilizers: bis(2,2,6,6-tetramethyl-4-piperidyl)sebacate, and dimethyl succinate/1-(2-hydroxy ethyl)-4-hydroxy-2,2,6,6-tetra methyl piperidine polycondensation;

salicylic acid type light stabilizers: p-t-butyl phenyl salicylate, and p-octyl phenyl salicylate;

benzophenone type: 2,4-dihydroxy benzophenone, 2-hydroxy-4-methoxy benzophenone, 2-hydroxy-4-methoxy-5-sulfobenzophenone, 2, and 2′-4 and 4′-tetrahydroxy benzophenone, 2,2′-dihydroxy-4-methoxy benzophenone, a 2,2′-dihydroxy-4,4′-dimethoxy benzophenone, bis(2-methoxy-4-hydroxy-5-benzoyl phenyl)methane;

benzotriazol type light stabilizers: 2-(2′-hydroxy-5′-methyl phenyl)benzotriazol, 2-(2′-hydroxy-5′-t-butylphenyl)benzotriazol, 2-(2′-hydroxy-3′ and 5′-di-t-butylphenyl)benzotriazol, 2-(2′-hydroxy-3′-t-butyl-5′-methyl phenyl)-5-chlorobenzotriazole, 2-(2′-hydroxy-3′ and 5′-di-t-butylphenyl)-5-chlorobenzothiazole, 2-(2′-hydroxy-5′-t-octylphenol) benzotriazol, 2-(2′-hydroxy-3′ and 5′-di-t-amyl phenyl)benzotriazol, 2,2′-methylene bis[4-(1,1,3,3-tetramethylbutyl)-6-(2H-benzotriazol 2-yl)phenol], 2(2′hydroxy-5′-metaacryloxyphenyl)-2H-benzotriazol, 2-[2′-hydroxy-3′-(3″, 4″, 5″6″-tetrahydrophthalimidomethyl)-5′-methyl-phenyl]benzotriazol, 2-(2′-hydroxy-5-acryloyl oxy ethyl phenyl)-2H-benzotriazol, 2-(2′-hydroxy-5′-methacryloxy ethylphenyl)-2H-benzotriazol, 2-(2′-hydroxy-3′-t-butyl-5′-acryloyl ethylphenyl)-5-chloro-2H-benzotriazol;

cyanoacrylate type light stabilizers: ethyl-2-cyano 3,3′-diphenyl acrylate;

light stabilizers other than those above: nickel bis(octyl phenyl)sulfide, [2,2′-thiobis(4-t-octylphenolate)]-n-butylamine nickel, nickel complex 3,5-di-t-butyl-mono-4-hydroxybenzylphosphorate ethylate, nickel.dibutyl dithiocarbamate, 2,4-di-t-butyl phenyl-3′,5′-di.t-butyl-4′-hydroxybenzoate, 2,4-di.t-butyl phenyl-3′,5′-di.t-butyl-4′-hydroxybenzoate, 2-ethoxy-2′-ethyl oxyzac acid bisanilide, and 2-(4,6-diphenyl-1,3,5-triazine 2-yl)-5-[(hexyl)oxy]-phenol.

In the present invention, it is desirable to employ an ultraviolet absorber or a hindered amine type light stabilizer, and it is still more desirable to use these in combination.

In the case that a light stabilizer is contained in a polymer layer, the desirable content of a light stabilizer is 0.1 to 30 mass % to a binder, more preferably 5 to 20 mass %. When the content is less than 0.1 mass %, weather resistance (light resistance) cannot be obtained sufficiently. On the other hand, when the content exceeds 30 mass %, since the transparency of a polymer layer is spoiled, it is not desirable.

Further, in the case that a light stabilizer is contained in a resin film, the desirable content of a light stabilizer is 0.1 to 5 mass % to a resin base material, more preferably 0.2 to 3 mass %. When the content is less than 0.1 mass %, deterioration prevention effect for UV rays becomes small. On the other hand, when the content exceeds 5 mass %, since the film producing characteristics of the resin film is lowered, it is not desirable.

In the present invention, in order to make the formation of a coating layer, such as a resin base material and a polymer layer, easier, it is desirable to mix other resin components appropriately to a light stabilizer in a coating layer. That is, it is desirable to use a resin component and a light stabilizer in a coating liquid state in which the resin component and the light stabilizer are dissolved in an organic solvent capable of dissolving the resin component and the light stabilizer, water, a mixture solution of two or more kinds of organic solvents, or a mixture solution of an organic solvent and water. Further, the resin component and the light stabilizer are separately dissolved or dispersed in advance in an organic solvent, water, a mixture solution of two or more kinds of organic solvents, or a mixture solution of an organic solvent and water, and the resultant resin component solution and light stabilizer solution are used by being mixed arbitrarily. Further, a copolymer of a resin component and a light stabilizer component is prepared in advance, and the copolymer may be used as a coating material as it is. The copolymer may be used by being dissolved in an organic solvent, water, a mixture solution of two or more kinds of organic solvents, or a mixture solution of an organic solvent and water. Examples of such a resin component to be mixed or copolymerized include, without being limited thereto, a polyester resin, a polyurethane resin, an acrylic resin, a methacrylic resin, a polyamide resin, a polyethylene resin, a polypropylene resin, a polyvinyl chloride resin, a polyvinylidene chloride resin, a polystyrene resin, a polyvinyl acetate resin, a fluorine type resin, etc. These resins may be used solely or used as a copolymer or a mixture of two or more kinds of them.

In the above resins, an acrylic resin or a methacrylic resin may be preferably selected and used, and further, it may be preferable to use a copolymer of an acrylic resin or a methacrylic resin with a light stabilizer for a coating layer. In the case of copolymerizing, it is preferable to copolymerize an acrylic monomer component or a methacrylic monomer component for a light stabilizer monomer component.

As the light stabilizer monomer component, for example, a benzotriazol-type reactive monomer, a hindered amine type reactive monomer, a benzophenone type reactive monomer, and the like can be used preferably. Any monomer having benzotriazol in a base body skeleton and an unsaturated bond may be used as a benzotriazol-type monomer, and examples of the benzotriazol-type monomer include, without being limited specifically thereto, 2-(2′-hydroxy-5-acryloyl oxy ethyl phenyl)-2H-benzotriazol, 2-(2′-hydroxy-5′-methacryloxy ethylphenyl)-2H benzotriazol, 2-(2′-hydroxy-3′-t-butyl-5′-acryloyl ethylphenyl)-5-chloro-2H-benzotriazol, and the like. Similarly, any monomer having hindered amine or benzophenone in a base body skeleton and an unsaturated bond may be used as a hindered amine type reactive monomer or a benzophenone type reactive monomer. Examples of a hindered amine type reactive monomer include, bis(2,2,6,6-tetramethyl-4-piperidyl 5-acryloyl oxy ethyl phenyl)sebacate, dimethyl-succinate 1-(2-hydroxy ethyl)-4-hydroxy-2,2,6,6-tetramethyl-5-acryloyl-oxy-ethyl-phenyl piperidine polycondensation, bis(2,2,6,6-tetramethyl-4-piperidyl 5-methacryloxy ethylphenyl)sebacate, dimethyl-succinate 1-(2-hydroxy ethyl)-4-hydroxy-2,2,6,6-tetramethyl-5-methacryloxy ethylphenylpiperidine polycondensation, bis(2,2,6,6-tetramethyl-4-piperidyl 5-acryloyl ethylphenyl)sebacate, dimethyl-succinate 1-(2-hydroxy ethyl)-4-hydroxy-2,2,6,6-tetramethyl-5-acryloyl ethylphenylpiperidine polycondensation. Further, examples of a benzophenone type reactive monomer include, 2-hydroxy-4-methoxy-5-oxyethyl phenyl benzophenone, 2 and 2′-4 and 4′-tetra-hydroxy-5-oxyethyl phenyl benzophenone, 2,2′-dihydroxy-4-methoxy-5-oxyethyl phenyl benzophenone, 2,2′-dihydroxy-4,4′-dimethoxy-5-oxyethyl phenyl benzophenone, 2-hydroxy-4-methoxy-5-methacryloxyethyl phenyl benzophenone, 2,2′-4,4′-tetra-hydroxy-5-methacryloxyethyl phenyl benzophenone, 2,2′-dihydroxy-4-methoxy-5-acryloyl ethyl phenyl benzophenone, 2,2′-dihydroxy-4,4′-dimethoxy-5-acryloyl ethyl phenyl benzophenone, and the like.

Examples of acrylic monomer components or methacrylmonomer component which are copolymerized with these light stabilizer monomer components, or their oligomer component, include: alkyl acrylate; alkyl methacrylate (as an alkyl group, i.e., a methyl group, an ethyl group, a n-propyl group, an isopropyl group, a n-butyl group, an isobutyl group, a t-butyl group, a 2-ethyl hexyl group, a lauryl group, a stearyl group, a cyclohexyl group, or the like); and monomers having a cross-linkable functional group, such as a carboxyl group, a methylol group, an acid anhydride group, a sulfonic acid group, an amide group, the methylol-natured amide group, an amino group, an alkylol-natured amino group, a hydroxyl group, an epoxy group, and the like. Further, the light stabilizer monomer components may be copolymerized with acrylonitrile, methacrylonitrile, styrene, butylvinyl ether, maleic acid, itaconic acid and its dialkyl ester, methyl vinyl ketone, vinyl chloride, vinylidene chloride, vinyl acetate, vinylpyridine, vinyl pyrrolidone, alkoxy silane having a vinyl group, unsaturated polyester, or the like.

The copolymerization ratio of these light stabilizer monomer components to the copolymerized monomers is not specifically restricted, and one kind or two or more kinds of each of them may be copolymerized at an arbitrary rate. However, the rate of the light stabilizer monomer component is preferably 10 mass % or more, more preferably 20 mass % or more, still more preferably 35 mass % or more, and preferably 70 mass % or less from the viewpoint of a coating ability and heat resistance. The light stabilizer monomer component may be a homopolymer. Although the molecular weight of these polymers is not limited specifically, it may be usually 5,000 or more, preferably 10,000 or more, and most preferably 20,000 or more in terms of the toughness of a coating layer. These polymers are used in the state that the polymers are dissolved or dispersed in an organic solvent, water or a mixture solution of an organic solvent/water. In addition to the above polymers, a hybrid type light stabilizer polymer of a marketed product, for example, U-DOUBLE (manufactured by NIPPON SHOKUBAI Co., Ltd.) may be employed.

In the case that a polyester film is used as a resin film, it is desirable to make an ultraviolet absorber to be contained as a light stabilizer in the polyester film. Examples of the ultraviolet absorber include: a salicylic acid type compound, a benzophenone type compound, a benzotriazol type compound, a cyanoacrylate type compound, a triazine type compound, a benzoxazinone type compound, an annular imino ester system compound, and the like. From the viewpoint of a UV ray intercepting ability at 380 nm, a color tone and a dispersibility in the polyester, a triazine type compound and a benzoxazinone type compound are particularly desirable.

Further, these compounds may be used solely or may be used in a combination of two or more kinds. Furthermore, stabilizers, such as HALS and an antioxidant may be used in combination, and preferably an antioxidant may be used in combination.

Here, examples of a benzotriazol type compound include: 2-(2H-benzotriazol 2-yl)-4,6-bis(1-methyl-1-phenylethyl)phenol, 2-(2H-benzotriazol 2-yl)-4-(1,1,3,3-tetramethylbutyl)phenol, 2-(2H-benzotriazol 2-yl)-4-methyl phenol, 2-(2H-benzotriazol 2-yl)-4,6-di-t-butyl phenol, 2-(2H-benzotriazol 2-yl)-4,6-di-t-p tert amylphenol, 2-(2H-benzotriazol 2-yl)-4-t-butyl phenol, 2-(2′-hydroxy-3′4-butyl-5′-methyl phenyl)-5-chlorobenzotriazole, and 2-(2′-hydroxy-3′,5′-di-t-butylphenyl)-5-chlorobenzotriazole.

Examples of a benzophenone type compound, include: 2-hydroxy-4-octhoxy benzophenone, 2-hydroxy-4-methoxy benzophenone, 2,2′-dihydroxy-4, a 4′-dimethoxy benzophenone, 2,2′ and 4,4′-tetra-hydroxy-benzophenone, 2,4-dihydroxy-benzophenone, and 2-hydroxy-4-methoxy benzophenone 5-sulfonic acid, and the like.

Examples of a benzoxazinone type compound, include: 2-p-nitrophenyl-3,1-benzoxazine 4-one, 2-(p-benzoyl phenyl)-3,1-benzoxazine 4-one, 2-(2-naphthyl)-3,1-benzoxazine 4-one, 2,2′-p-phenylenebis(3,1-benzoxazine 4-one), and 2,2′-(2,6-naphthylene) bis(3,1-benzoxazine 4-one), and the like.

<<ceramic Layer>>

The weather resistance resin base material of the present invention is characterized in that the resin base material has at least one layer of a ceramic layer which is composed of an oxide containing Si or Al, a nitrogen oxide containing Si or Al, or nitride containing Si or Al as a main component. on at least one side of the resin base material.

These ceramic layers have low permeability for moisture or gas and a low refractive index and constitute a gas barrier layer. Further, in the case that the ceramic layer is provided on the uppermost layer, a handling ability improves as well as the improvement of durability, whereby it becomes possible to obtain a weather resistance resin base material which is hardly damaged and hardly causes color tone change even if being damaged slightly.

As a forming method of such a ceramic layer, a vapor phase growth method is preferable. Further, a vacuum deposition method, a sputtering method, an ion plating method, a catalyst chemical-vapor deposition (Cat-CVD) method, or a plasma CVD method is more desirable. Especially, by a thin film forming method which feeds a gas containing a thin film forming gas and a discharge gas in a discharge space under an atmospheric pressure or a pressure in the vicinity of the atmospheric pressure; applies a high frequency electric field in the discharge space so as to excite the gas; and exposes a resin base material to the excited gas, a thin film is formed on the resin base material. Such a thin film, that is, a film formed by the so-called atmospheric pressure plasma CVD method is preferable because of a low residual stress.

The atmospheric pressure plasma method and the formation, by the atmospheric pressure plasma method, of the low refractive index ceramic layer composed of at least an oxide containing Si or Al, a nitrogen oxide containing Si or Al, or a nitride containing Si or Al as a main component will be described later.

In the present invention, it is desirable that the refractive index of a ceramic layer is 1.3 or more and less than 1.8. When the refractive index is made less than 1.8, since durability and a handling ability can be raised while hardly affecting visible light transmittance and infrared reflectance, the layer design of a low refractive index layer can be conducted relatively freely. On the other hand, when the refractive index becomes less than 1.3, a film becomes less dense and improvement in durability cannot be expected.

In the present invention, the above ceramic layer is preferably composed of silicon oxide films and preferably includes at least one or more layers of silicon oxide films which are different in carbon content respectively.

These silicon oxide films are approximately same composition. However, when thin films are formed by the use of a vapor phase growth method, for example, in the case of an atmospheric pressure plasma CVD method, some difference takes place in the degree of filling of silicon oxide particles or in impurity particles mixed slightly in accordance with manufacturing conditions or used thin film forming gas (i.e., kinds of raw stock gas and additive gas, ratio, etc.), so that physical properties, such as a density and the like may become different.

The refractive index of a ceramic layer is preferably 1.3 or more and less than 1.8. Specifically, the value obtained by the X-ray reflectivity technique is used for the refractive index of an silicon oxide film, for example.

### (X-Ray Reflectivity Technique)

The X-ray reflectivity technique can be conducted with reference to “X-ray Diffraction Handbook” page 151 (edited by Rigakudenki Co., Ltd., 2000, International Academic Printing Co., Ltd.) or Kagaku Kogyo, January 1999, No. 22.

Hereafter, a specific example of a measurement technique useful in the invention will be explained.

This technique conducts measurement by making X-rays to enter a flat surface of a material at a very shallow angle by using MXP 21, produced by Mac Science Corp as a measurement apparatus. The X-ray source employs copper as a target and is operated with 42 kV and 500 mA. The measurement apparatus employs a multi-layer parabola mirror as an incident monochrometer and also employs an incident slit with a size of 0.05×5 mm and a light receiving slit with a size of 0.03×20 mm. The measurement is conducted by a FT method with a step width of 0.005° and 10 seconds for one step for a range of 0 to 5° with a 2θ/θ scanning technique. The obtained reflectance curve is subjected to curve-fitting by the use of Reflectivity Analysis Program Ver. 1 manufactured by Mac Science Corporation to obtain respective parameters so that the residual sum of squares between the measurement values and the fitting curve becomes the minimum. The refractive index, thickness and density of the laminated layers are obtained from the respective parameters.

The density of a silicon oxide film has correlation closely with the content of carbon which is a minor component. For example, a film having a low carbon atom concentration (less than 0.1 at %) is a film having a high density and a high gas barrier property. However, a film having a carbon atom concentration (1 to 40 at %) higher than the above has a low film density and is a soft composition.

In the present invention, the carbon content (at %) of a ceramic layer represents an atomic number concentration % (atomic concentration).

The atomic concentration or percent by number of atoms representing the carbon content can be obtained by a well-known analysis technique. However, in the invention, the atomic concentration is calculate by the following XPS method, and is defined as follows:

Atomic number concentration % (atomic concentration)=(the number of carbon atoms)/(the total number of atoms)×100

In the present invention, ESCALAB-200R manufactured by VG Scientific Corporation was used an XPS surface analyzer. Specifically, Mg was used for an X-ray anode and the measurement was conducted with an output of 600 W (accelerating voltage: 15 kV, emission current: 40 mA). Energy resolving power was set to 1.5 eV to 1.7 eV at the time of being defined with a half width of a clean Ag3d5/2 peak.

In the measurement, first, a bonding energy range of 0 eV to 1100 eV was measured with a data sampling interval of 1.0 eV so as to obtain that what elements are detected.

Then, a narrow scanning was conducted for all the detected elements except etching ion species with a data sampling interval of 0.2 eV so as to detect a photoelectron peak giving their maximum intensity, whereby the spectrums of the respective element were measured.

In order to eliminate differences in calculation results of content percentages due to the differences of measuring devices or computers, the obtained spectrums were transferred to COMMON DATA PROCESSING SYSTEM, manufactured by VAMAS-SCA-JAPAN Corporation (preferably Ver. 2.3 or later one) and processed by the above software, whereby the value of the content percentage of the respective targeted elements (carbon, oxygen, silicon, titanium and the like) were obtained as the atomic number concentration (atomic concentration: at %).

Before quantitative analysis was conducted, calibration with Count Scale was conducted for the respective elements so as to conduct a smoothing treatment with 5 points. The quantitative analysis was conducted by the use of a peak area intensity (cps*eV) from which backgrounds were eliminated. In the background processing, a method by Shirley was employed. The Shirley method can be referred to D. A. Shirley, Phys. Rev., B5, 4709 (1972).

With regard to a method of producing the above ceramic layer according to the present invention, for example, the first, second, or third silicon oxide film, now, an explanation is made about raw material compounds used in a producing method by a vapor phase growth method, specifically, by an atmospheric pressure plasma CVD method.

In these silicon oxide films, the composition of a ceramic layer composed of an oxide containing Si or Al, a nitrogen oxide containing Si or Al and a nitride containing Si or Al as a main component may be changed by the selection of conditions in an atmospheric pressure plasma CVD method, such as organometal compounds of raw materials (also referred to as basic ingredients), cracked gas, decomposition temperature and supplied power.

For example, when a silicon compound is employed as a raw material compound and oxygen is employed as cracked gas, a silicon oxide is produced. When silazane and the like are employed as a raw material compound, a silicon oxide nitride is produced. The reason is that since very active charged particles and active radicals exist with high density in a plasma space, multistage chemical reactions are advanced at very high speed in the plasma space, so that elements existing in the plasma space are converted to a thermodynamically stable compound in a very short time.

As formation raw materials of such a silicon oxide film, as long as the raw materials are a silicon compound, any state of gas, liquid, and solid under ordinary temperatures and pressures may be permissible. In the case of gas, the raw materials can be introduced in a discharge space as they are, but when the raw materials are liquid or solid, the raw materials are used by being evaporated by means of heat, bubbling, reduced pressure, ultrasonic irradiation, or the like. Further, the raw materials may be used by being diluted with a solvent. As such a solvent, an organic solvent, such as methanol, ethanol, and n-hexane, and a mixed solvent of these solvents can be used. Here, since these diluting solvents are decomposed into molecules or atoms during the plasma discharge treatment, their influence can be almost disregarded.

Examples of the silicon compounds include: silan, tetra methoxy silan, tetra ethoxy silan, tetra n-propoxy silan, tetra isopropoxy silan, tetra n-butoxy silan, tetra t-butoxy silan, dimethyldimethoxy silan, dimethyldiethoxy silan, diethyldimethoxy silan, diphenyldimethoxy silan, methyl triethoxy silan, ethyl trimethoxy silan, phenyl triethoxy silan, (3,3,3-trifluoropropyl)trimethoxy silan, hexamethyl disiloxan, bis(dimethylamino)dimethyl silan, bis(dimethylamino)methylvinyl silan, bis(ethylamino)dimethyl silan, N,O-bis(trimethyl silyl)acetamide, bis(trimethyl silyl)carbodiimide, diethyl aminotrimethyl silan, dimethylamino dimethyl silan, hexamethyl disilazan, hexamethyl cyclotrisilazan, heptamethyl disilazan, nonamethyl trisilazan, octamethylcyclo tetrasilazane, tetrakis dimethylamino silan, tetraisocyanate silan, tetramethyl disilazan, tris (dimethylamino)silan, triethoxyfluoro silan, allyldimethyl silan, allyl trimethyl silan, benzyl trimethyl silan, bis(trimethyl silyl)acetylene, 1,4-bistrimethyl silyl-1,3-butadiyn, di-t-butyl silan, 1,3-disilabutan, bis(trimethyl silyl)methan, cyclopentadienyl trimethyl silan, phenyl dimethyl silan, phenyl trimethyl silan, propargyl trimethyl silan, tetramethyl silan, trimethyl silyl acetylene, 1-(trimethyl silyl)-1-propyn, tris(trimethyl silyl)methan, tris(trimethyl silyl)silan, vinyl trimethyl silan, hexamethyl disilan, octamethyl cyclotetrasiloxan, tetramethyl cyclotetrasiloxan, hexamethyl cyclotetrasiloxan, M silicate 51, and the like.

Examples of the aluminium compounds, include: aluminium ethoxide, aluminium triisopropoxide, aluminium isopropoxide, aluminium n-butoxide, aluminium s-butoxide, aluminium t-butoxide, aluminium acetylacetonato, triethyl dialuminium tri-s-butoxide, and the like.

Further, examples of cracked gas for decomposing raw stock gas including these silicon and aluminium so as to obtain a silicon oxide film or an aluminum oxide film, include: hydrogen gas, methane gas, acetylene gas, carbon monoxide gas, carbon dioxide gas, nitrogen gas, ammonia gas, nitrous oxide gas, nitrogen oxide gas, nitrogen dioxide gas, oxygen gas, steam, fluorine gas, hydrogen fluoride, trifluoroalcohol, trifluorotoluene, hydrogen sulfide, sulfur dioxide, carbon disulfide, chlorine gas, and the like.

For example, in the case of selecting a raw stock gas containing silicon and a cracked gas suitably, it becomes possible to obtain a silicon oxide film which contains a silicon oxide and a nitride, a carbide, and the like.

In a plasma CVD method, a discharge gas which becomes a plasma state easily is mainly mixed to these reactive gases, and the resultant mixed gas is fed into a plasma discharge generator. As such a discharge gas, nitrogen gas and/or the 18th group atom in a periodic table, such as, helium, neon, argon, krypton, xenon, radon, etc. are employed. Among them, nitrogen, helium, and argon are preferably used specifically.

The above-mentioned discharge gas and reactive gas are mixed, and the resultant mixed gas is fed as a thin film forming (mixed) gas to a plasma discharge generator (plasma generation apparatus), whereby a film formation is conducted. Although the ratio of the discharge gas and the reactive gas may be different depending on the characteristics of a film to be obtained, the reactive gas is fed such a way that the ratio of the discharge gas to the whole mixed gas is made 50% or more.

In the laminated silicon oxide film which constitutes a ceramic layer, for example, oxygen gas or nitrogen gas is combined with the abovementioned organosilicon compound at a predetermined ratio so that it becomes possible to obtain a silicon oxide film according to the invention in which a silicon oxide containing Si atom and at least one of O atom and N atom is made as a main component.

In the ceramic layer, a unit of a group is composed of the first silicon oxide film, second silicon oxide film, and the like, and one or more groups are preferably formed on a resin base material, or two groups or more may be formed. As an example, there is a configuration comprising only a unit of one group such as the first silicon oxide film and the second silicon oxide film on a resin base material, or, for example, a configuration may be structured to comprise two or three units each composed of the first silicon oxide film and the second silicon oxide film on a resin base material.

In the ceramic layer, the thickness of each silicon oxide layer may be in a range of 1 to 500 nm. The thickness of the entire body of the ceramic layer is preferably in a range of 10 nm to 5 μm.

Next, an atmospheric plasma CVD method will be explained in detail.

For the formation of the ceramic layer, such as a silicon oxide layer, or these laminated layers according to the present invention, physical or chemical vapor phase growth methods are employed. Especially, an atmospheric plasma CVD method which is the most preferable method among them will be explained.

Such an atmospheric plasma CVD method is described in, for example, the official document of Japanese Unexamined Patent Publication Nos. 10-154598 and 2003-49272 and the pamphlet of WO 02/048428. Specifically, the thin film forming method described in the official document of Japanese Unexamined Patent Publication No. 2004-68143 is preferable to form a silicon oxide film which is dense and has high gas barrier properties. Further, silicon oxide films different in composition can be continuously formed while a web-shaped resin base material is unwound from a roll-like source roll.

The above atmospheric pressure plasma CVD method used to form a ceramic layer according to the present invention is a plasma CVD method conducted under atmospheric pressure or its near pressure. The atmospheric pressure or its near pressure is about a pressure of 20 to 110 kPa, and preferably between 93 to 104 kPa in order to obtain the good effects described in the present invention.

In the formation of a silicon oxide film as an example of a film constituting a ceramic layer, as the discharge conditions, it is preferable to form two or more electric fields different in frequency in a discharge space, and to superimpose a first high frequency electric field and a second high frequency electric field so as to form an electric field.

The frequency ω2 of the second high frequency electric field is higher than the frequency ω1 of the first high frequency electric field, and the strength V1 of the first high frequency electric field, the strength V2 of the second high frequency electric field, and the strength IV of a discharge starting electric field satisfy the relationship of:

V1≧IV>V2 or

V1>IV≧V2, and

the output density of the second high frequency electric field is 1 W/cm² or more.

The term “high frequency wave” refers to a wave having a frequency of at least 0.5 kHz.

When both of the superimposed high frequency electric fields are a sine wave respectively, the superimposed high frequency electric fields become such a composition that the frequency ω1 of the first high-frequency electric field and the frequency ω2 of the second high frequency electric field higher than the frequency ω1 are superposed, and its waveform becomes a sawtooth waveform in which on the sine wave of the frequency ω1, the sine wave of the frequency ω2 higher than the frequency ω1 is superimposed.

In the present invention, “discharge starting electric field strength (the strength of a discharge starting electric field)” refers to the lowest electric field strength capable of causing discharge in a discharge space (structured by electrodes) and under reaction conditions (such as gas conditions) which are practically used in the thin film forming method. The discharge starting electric field strength may vary some extent depending on the types of gases fed to the discharge space, the types of the dielectric substances of electrodes, and the distance between the electrodes. However, the discharge starting electric field strength in the same discharge space is determined by the discharge starting electric field strength of the discharge gases.

It is assumed that the formation of such a high frequency electric filed as described above in a discharge space causes discharge capable of forming thin films, whereby it is possible to generate high density plasma necessary for forming high quality thin films.

Here, an important thing is that such a high frequency electric field is formed between electrodes opposite to each other, that is, in the same discharge space. It is undesirable that according to a method described in Japanese Unexamined Patent Publication No. 11-16696, two electrodes are arranged side by side and different high frequency electric fields are formed separately in respective different discharge spaces.

In the above, the superimposition of continuous waves, such as sine waves, was described. The present invention is not limited to this example, and both waves may be pulse waves, or one wave may be a continuous wave and the other may be a pulse wave. Further, a third electric field with a different frequency may be included.

A specific method in which the high-frequency electric field of the present invention is formed in the same space employs an atmospheric pressure plasma discharge processing apparatus in which, for example, a first power source to form the first high-frequency electric field with a frequency of ω1 and an electric field strength of V1 is connected to the first electrode which constitutes an opposite electrode, and a second power source to form the second high-frequency electric field with a frequency of ω2 and an electric field strength of V2 is connected to the second electrode.

The above atmospheric pressure plasma discharge processing apparatus is provided with a gas feeding means which feeds discharge gases and thin film forming gases between the opposite electrodes. Further, it is preferable to provide an electrode temperature controlling means to control the electrode temperature.

Further, it is preferable that a first filter is connected to any one of the first electrode, the first power source, or the place between them, and a second filter is connected to any one of the second electrode, the second power source, or the place between them. The first filter makes an electric current in the first high-frequency electric field to easily pass from the first power source to the first electrode, and grounds the electric current of the second high-frequency electric field such that the electric current in the second high-frequency electric field is made to not easily pass from the second power source to the first power source. Further, the employed second filer has the function reverse to the above, that is, the second filter makes an electric current in the second high-frequency electric field to pass easily from the second power source to the second electrode, and grounds the electric current in the first high-frequency electric field such that the electric current in the first high-frequency electric field is made to not easily pass from the first power source to the second power source. Here, the expression “not easily pass” means that the electric current is made to pass preferably only 20% or less, and more preferably only 10% or less. On the contrary, the expression “easily pass” means that the electric current is made to pass preferably 80% or more, and more preferably 90% or more.

For example, as a first filter, employable is a capacitor at several tens pF to several ten thousands pF, or a coil of several μH in accordance with the frequency of the second power source. As the second filter, a coil of 10 μHor more is employed in accordance with the frequency of the first power source, and when this coil is grounded through a capacitor, the coil can be used as a filter.

Further, it is preferable that the first power source of the atmospheric pressure plasma discharge processing apparatus of the present invention has a capability of forming an electric field strength higher than that of the second power source.

Herein, the “electric field strength” and “discharge start electric field strength” refer to those measured by the following methods.

Measurement Method of Electric Field Strengths V1 and V2 (unit: kV/mm):

A high-frequency voltage probe (P6015A) is provided to each electrode section, the output signals of the above high-frequency voltage probes are connected to an oscilloscope (IDS3012B, produced by Tektronix, Inc.), and the electric field strength at a predetermined time is determined.

Measurement Method of Discharge Start Electric Field Strength IV (unit: kV/mm)

Electric discharge gases are supplied between the electrodes, and the electric filed strength between the above electrodes is increased. At this time, an electric field strength at which discharge is started is defined as an electric discharge start electric field strength IV. The measurement apparatus is the same as that employed to measure the above formed electric field strength measurement.

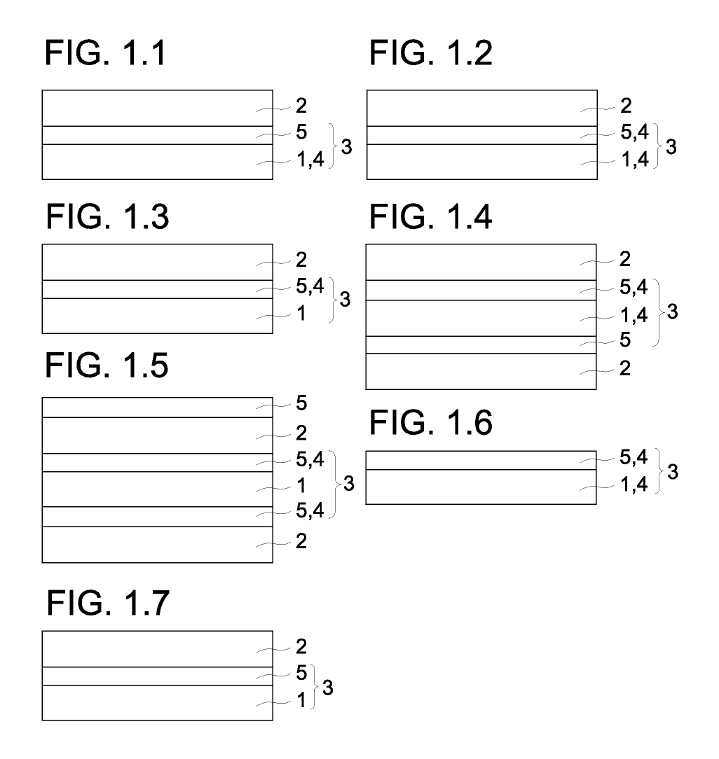

Incidentally, the measurement position of the electric field strength via the high-frequency voltage probe and the oscilloscope employed for the above measurements is illustrated in the FIG. 1 mentioned later.

With the employment of the discharge conditions specified in the present invention, even if a discharge gas is nitrogen gas whose discharge start electric field is high, it is possible to start discharging and maintain a stable plasma state at a high density, whereby it is possible to form a thin film formation with high performance.

In the above measurement, in the case where nitrogen gas is employed as a discharge gas, and the discharge start electric field strength IV (½Vp-pp) is about 3.7 kV/mm. Consequently, in the above relationship, when the first electric field intensity is made to satisfy the conditional formula: V1≧3.7 kV/mm, it becomes possible to excite the nitrogen gas and to form a plasma state.

At this time, as a frequency of the first power source, it is preferable to employ 200 kHz or less. Further, the waveform of the above electric field may be a continuous wave or a pulse wave. The lower limit is preferably about 1 kHz.

On the other hand, as a frequency of the second power source, it is preferable to employ 800 Hz or more. As the frequency of the above second power source becomes higher, the obtained plasma density becomes high and a obtained thin film becomes dense and high quality. The upper limit is preferably about 200 MHz.

It is important to form high-frequency electric fields with such two power sources, because the first high-frequency electric field is needed to start the discharging of a discharge gas having a relatively high discharge start electric field strength, and the second high-frequency electric field is needed to make the plasma density high and to form a dense and good quality thin film with its high frequency and high output density.

Further, when the output density of the first high-frequency electric field is made high, it is possible to enhance the output density of the second high-frequency electric field while maintaining the uniformity of the discharge. With this, it becomes possible to produce a more uniform high density plasma, and it is possible to satisfy both to increase the film producing rate and to enhance the film quality.

The atmospheric pressure plasma discharge processing apparatus employed in the present invention, as described above, causes discharging between opposite electrodes so as to make gases introduced between the above opposite electrodes into a plasma state, and exposes a base material placed on still standing or being conveyed between the above opposite electrodes to the gases in the plasma state, thereby forming a thin film on the base material. Further, as a jet type apparatus as another system, the atmospheric pressure plasma discharge processing apparatus causes discharging between opposite electrodes so as to excite gases introduced between the above opposite electrodes or to make the gases into a plasma state, blows out the excited gasses or the gas in the plasma state in the form of a jet to the outside of the opposite electrodes, and exposes a base material (placed on still standing or being conveyed) in the vicinity of the opposite electrodes to the brown-out gases, thereby forming a thin film on the base material.

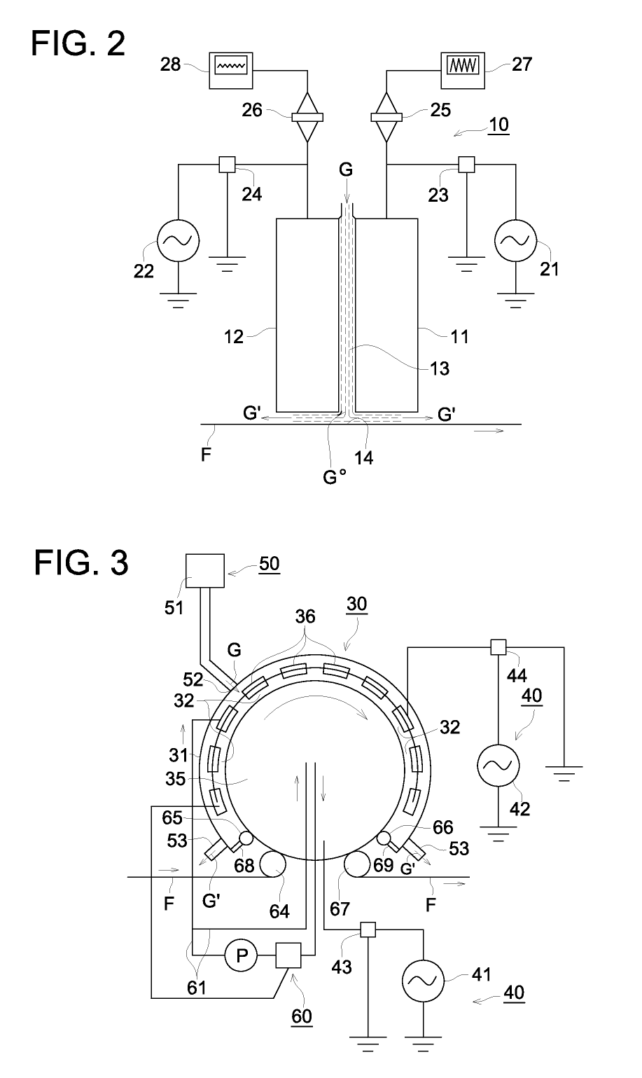

FIG. 2 is a schematic view showing one example of the jet type atmospheric pressure plasma discharge processing apparatus which is useful in the present invention.

The jet type atmospheric pressure plasma discharge processing apparatus is an apparatus which comprises a gas feeding means, and an electrode temperature regulating means, not shown in FIG. 2 (though shown in FIG. 3 below), in addition to a plasma discharge processing apparatus and an electric field forming means having two power sources.

A plasma discharge processing apparatus 10 comprises opposite electrodes composed of a first electrode 11 and a second electrode 12, and between the above opposite electrodes, a first high-frequency electric field with a frequency ω1, an electric field intensity V1, and an electric current I1 is formed by the first electrode 11, and a second high-frequency electric field with a frequency ω2, an electric field intensity V2, and an electric current I2 is formed by the second electrode 12. The first power source 21 achieves the formation of the high-frequency electric field strength (V1>V2) which is higher than that of second power source 22, while the first power source 21 applies the first frequency ω1 which is lower than the second frequency ω2 of the second power source 22.

Between the first electrode 11 and the first power source 21, arranged is the first filter 23 which is designed in such a manner that the electric current from the first power source 21 to the first electrode 11 is made to flow easily, while the electric current from second power source 22 is grounded, so that the electric current from second power source 22 to first power source 21 is made not to flow easily.

Further, between the second electrode 12 and the second power source 22, arranged is the second filter 24 which is designed in such a manner that the electric current from second power source 22 to the second electrode is made to easily flow, while the electric current from first electrode 21 is grounded, so that the electric current from first electric power 21 to the second power source is made to not flow easily.

The abovementioned thin film forming gases G are introduced into a space (a discharge space) 13 between the opposite electrodes composed of the first electrode 11 and the second electrode 12 from the gas feeding means as shown in FIG. 3 mentioned later. The abovementioned high-frequency electric fields are formed between the first electrode 11 and the second electrode 12 by the first power source 21 and the second power source 22 so as to cause discharging. As a result, while the above thin film forming gases G are being made in a plasma state, the resultant gases are blown out onto the beneath (lower side of a sheet) of the opposite electrodes, so that the processing space formed between the bottom surface of the opposite electrodes and a resin base material F is filled with gas G° in the plasma state. Subsequently, a thin film is formed in the vicinity of the processing position 14 on the resin base material F which is conveyed from the source roll (not shown) of a long base material while being unwound, or conveyed from a previous process. During the thin film formation, the electrodes may be heated or cooled with a media fed through a pipe from the electrode temperature regulating means as shown in FIG. 3 mentioned below. Depending on the temperature of the base material at the time of the plasma discharge processing, the physical properties and compositions of the obtained thin film may vary. Accordingly, in order to counter these variations, it is preferable to control the temperature appropriately. As a temperature controlling media, preferably employed are insulation materials such as distilled water or oil. During the plasma discharge processing, it is preferable that the temperature of the insides of the electrodes are controlled to be uniform so as to prevent non-uniform temperature from taking place in the lateral and longitudinal directions of the base material.

Further, FIG. 2 shows measuring instruments to measure the abovementioned electric field strength and the discharge start electric field strength and measuring positions. In FIGS. 2, 25 and 26 each represents a high-frequency voltage probe, and 27 and 28 each represents an oscilloscope.

When a plurality of jet type atmospheric plasma discharge processing apparatuses are arranged in parallel to the conveying direction of a resin base material F, and the gases being in the same plasma state are brown out simultaneously, it becomes possible to form a thin film with plural layers in the same position on the resin base material F, whereby it is possible to form a desired film thickness within a short time. Further, when a plurality of apparatuses are arranged in parallel to the conveying direction of the base material F, different thin film forming gases are supplied to respective apparatuses so as to blow out gases in different plasma state, whereby it is possible to form a laminated thin film composed of different layers.

FIG. 3 is a schematic view showing one example of an atmospheric pressure plasma discharge processing apparatus with a type which processes a base material between the opposite electrodes and is useful in the present invention.

The atmospheric pressure plasma discharge processing apparatus of the present invention is an apparatus which comprises at least a plasma discharge processing apparatus 30, an electric field forming means having two power sources, a gas feeding means 50, and an electrode temperature regulating means 60.

In a space 32 between opposite electrodes (hereafter, referred to as a discharge space 32) of a roll-shaped rotating electrode (first electrode) 35 and a square tube type fixed electrode group (second electrode) (hereafter, the square tube type fixed electrode group is referred to as a fixed electrode group) 36, a base material F is subjected to a plasma discharge processing so that a thin film is formed on the base material F.

The atmospheric pressure plasma discharge processing apparatus is designed such that in the discharge space 32 formed between the roll-shaped rotating electrode 35 and the fixed electrode group 46, the first high-frequency electric field with a frequency ω1, an electric field strength V1 and an electric current I1 is applied from the first power source 41 to the roll-shaped rotating electrode 35, and the second high-frequency electric field with a frequency ω2, an electric field strength V2 and an electric current I2 is applied from the second power source 42 to the fixed electrode group 36.

A first filter 43 is arranged between the roll-shaped rotating electrode 35 and the first power source 41, and the first filter 43 is designed such that the electric current from the first power source 41 to the first electrode is made to pass easily, and the electric current from the second power source 42 is grounded so that the electric current from the second power source 42 to the first power source is made not to pass easily. Further, a second filter 44 is arranged between the fixed electrode group 36 and the power source 42, and the second filter 44 is arranged such that the electric current from the second power source 42 to the second electrode is made to pass easily, and the electric current from the first power source 41 is grounded so that the electric current from the first power source 41 to the second power source is made not to pass easily.

In the present invention, the roll-shaped rotating electrode 35 may be employed as the second electrode, and the square tube type fixed electrode group 36 may be employed as the first electrode. In any case, the first electrode is connected to the first power source, while the second electrode is connected to the second power source. It is preferable that the first power source is adapted to form a high-frequency electric field strength (V1>V2) higher than that of the second power source. Further, the first power source has a capability to make a frequency to be ω1<ω2.

Further, it is preferable that electric current I1<electric current I2. The electric current I1 of the first high-frequency electric field is preferably 0.3 to 20 mA/cm², and is more preferably 1.0 to 20 mA/cm². Further, the electric current I2 of the second high-frequency electric field is preferably 10 to 100 mA/cm², and is more preferably 20 to 100 mA/cm².

The thin film forming gas G generated by the gas generating apparatus of the gas feeding means 50 is subjected to a flow rate control by a gas flow rate regulating means (not shown in the drawings), and is introduced into the plasma discharge processing chamber 31 through a gas feeding port 52.

The base material F is unwound from the source roll (not shown), and is conveyed into the plasma discharge processing chamber 31. Alternatively, the base material F is conveyed in the arrowed direction from the previous process into the plasma discharge processing chamber 31, and after the base material F passes a guide roller 64, air accompanying on the base material F is blocked with a nip roller 65, and then, the base material F is conveyed among the square tube type fixed electrode group 36 while being brought in contact with the roll-shaped rotating electrode 35 and wound.

During the conveyance, the electric fields are applied from both of the roll-shaped rotating electrode 35 and the fixed electrode group 36 such that discharge plasma is generated in the space between the opposite electrodes (discharge space) 32. While the base material F is brought into contact with the roll-shaped rotating electrode 35 and is wound, a thin film is formed on the base material F with gases in the plasma state.

Here, as the number of the square tube type fixed electrodes, a plurality of square tube type fixed electrodes are arranged along the circumference larger than that of the roll-shaped rotating electrode 35, and the discharge area of the above the square tube type fixed electrodes is calculated as the sum of the areas of the surfaces of the squared cylindrical fixed electrodes opposite to the roll-shaped rotating electrode 35.

After having passed the nip roller 66 and the guide roller 67, the base material F is wound by a winding machine (not shown), or conveyed to the following process.

The processed exhaust gases G′ having been used to the discharge process are discharged from an exhaust gas port 53.

During the formation of a thin film, in order to heat or cool the roll-shaped rotating electrode 35 and the fixed electrode group 36, media of which temperature is regulated by the electrode temperature regulating means 60, is fed to the both electrodes through the pipe 61 by the liquid transporting pump P such that the temperature is regulated from the inside of the electrodes. Here, 68 and 69 are partition plates which separate the plasma discharge processing chamber 31 from the outside.

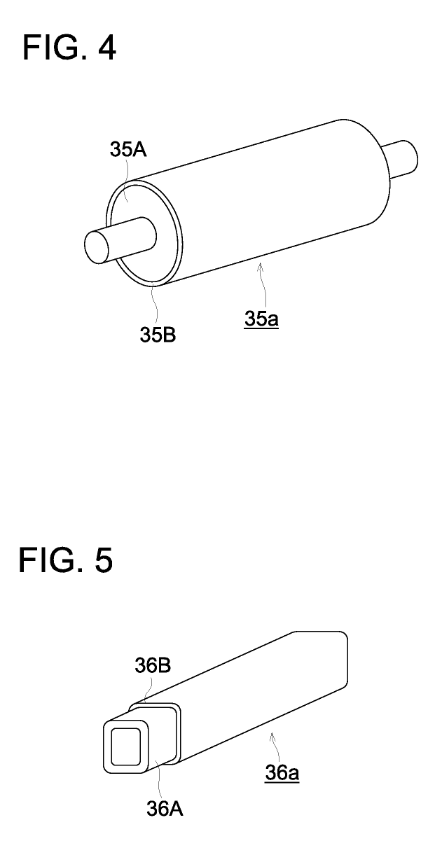

FIG. 4 is a perspective view showing one example of the structure of an electrically conductive metallic base material of the roll-shaped rotating electrode shown in FIG. 3 and a dielectric substance covering the base material.

In FIG. 4, a roll-shaped electrode 35a comprises an electrically conductive metallic base martial 35A and a dielectric substance 35B covering the base martial 35A. Further, in order to control the surface temperature of the electrode during the plasma discharge processing and to maintain the surface temperature of the resin base material F at a predetermined value, the roll-shaped electrode 35a is structured such that a medium (such as water or silicone oil) for regulating temperature can circulate.

FIG. 5 is a perspective view showing one example of a structure of an electrically conductive base material of the square tube type electrode and a dielectric substance covered on the base material.

In FIG. 5, the square tube type electrode 36a comprises a covering of a dielectric substance 36B as with FIG. 4 on a conductive metallic base 36A, and the structure of this electrode is a metallic pipe so that the metallic pipe functions as a jacket for conducting regulating temperature during discharging.

The square tube type electrode 36a shown in FIG. 5 may be a cylinder type electrode. However, since the square tube type electrode has an effect to broaden a discharge range (a discharge area) as compared with the cylinder type electrode, the square tube type electrode is preferably employed in the present invention.

In FIGS. 4 and 5, the roll-shaped rotating electrode 35a and the square tube type electrode 36a are produced in such a way that ceramics as the dielectric substances 35B and 36B is thermally sprayed on the electrically conductive metallic base materials 35A and 36B respectively, and thereafter, the base materials 35A and 36B are subjected to a pore sealing process with a pore sealing material of an inorganic compound. The ceramic dielectric substances may have a thickness of about 1 mm on one side. As the ceramic materials used for the thermal spray, alumina, silicon nitride and the like are preferably employed. Among them, alumina is specifically preferable, because it is easily processed. Further, the dielectric substance layer may be a lining-processed dielectric substance in which inorganic materials are provided by lining.

Examples of the electrically conductive base materials 35A and 36B include: metal titanium, titanium alloys, metals such as silver platinum, stainless steel, aluminum, and iron, composite materials of iron and ceramics, and composite materials of aluminum and ceramics. Due to the reasons mentioned later, titanium metal and titanium alloys are specifically preferable.

In the case where a dielectric substance is provided on one electrode, a distance between the first electrode and the second electrode which are opposite to each other is the shortest distance between the surface of the dielectric substance of the electrode and the surface of a conductive metallic base marital of another electrode. In the case where a dielectric substance is provided on both electrodes, a distance between the first electrode and the second electrode is the shortest distance between the surfaces of the respective dielectric substances. The distance between the electrodes is determined in consideration with the thickness of the dielectric substances provided on the conductive metallic base materials, the degree of electric field strength, and purposes to utilize plasma. However, in any case, from the viewpoint of conducting discharge uniformly, the distance is preferably 0.1 to 20 mm, and specifically preferably 0.5 to 2 mm.

The conductive metallic base materials and the dielectric substances, which are useful in the present invention, will be explained later in detail.

As the plasma discharge processing chamber 31, a processing chamber made of a PYREX (the registered trade name) glass is preferably employed. However, when the insulation of the electrode is established, it is possible to employ a metal chamber. For example, in the metal chamber, polyimide resins may be pasted to the inner surface of an aluminum or stainless steel frame, or ceramics may be thermally sprayed so as to establish insulation. In FIG. 3, it is preferable that both sides (near the surface of a base material) of the both parallel electrodes are covered with the materials as described above.

As the first power source (high-frequency power source) arranged in the atmospheric pressure plasma discharge processing apparatus, the following are available as commercial products, and are employable.

| Power | | | |
|---|---|---|---|
| Source No. | Manufacturer | Frequency | Trade Name |
| A1 | Shinko Electric Co., Ltd. | 3 kHz | SPG3-4500 |
| A2 | Shinko Electric Co., Ltd. | 5 kHz | SPG5-4500 |
| A3 | Kasuga Electric Work Ltd. | 15 kHz | AGI-023 |
| A4 | Shinko Electric Co., Ltd. | 50 kHz | SPG50-4500 |
| A5 | Haiden Laboratory, Inc. | 100 kHz* | PHF-6k |
| A6 | Pearl Kogyo Co., Ltd. | 200 kHz | CF-2000-200k |
| A7 | Pearl Kogyo Co., Ltd. | 400 kHz | CF-2000-400k |

Further, as the second power source (high-frequency power source), the following are available as commercial products, and are employable.

| Power | | | | |
|---|---|---|---|---|
| Source No. | Manufacturer | Frequency | | Trade Name |
| B1 | Pearl Kogyo Co., Ltd. | 800 | kHz | CF-2000-800k |
| B2 | Pearl Kogyo Co., Ltd. | 2 | MHz | CF-2000-2M |
| B3 | Pearl Kogyo Co., Ltd. | 13.56 | MHz | CF-5000-13M |
| B4 | Pearl Kogyo Co., Ltd. | 27 | MHz | CF-2000-27M |
| B5 | Pearl Kogyo Co., Ltd. | 150 | MHz | CF-2000-150M |

Among the above power sources, the power source provided with asterisk mark * is a high-frequency power source (100 kHz in a continuous mode) manufactured by Haiden Laboratory, Inc. Other power sources are a high-frequency power source capable of applying only continuous sine waves.

In the present invention, it is preferable in the atmospheric pressure plasma discharge processing apparatus to employ electrodes capable of maintaining a uniform and stable discharge state by forming such electric fields.

In the present invention, as an electric power applied between the opposite electrodes, an electric power (output density) of 1 W/cm² or more is fed to the second electrode (the second high-frequency electric field) so as to excite discharge gases and to cause plasma, whereby energy is provided to thin film forming gases and a thin film is formed. The upper limit of the electric power fed to the second electrode is preferably 50 W/cm², and more preferably 20 W/cm². The lower limit is preferably 1.0 W/cm². Here, a discharge area (cm²) refers to an area in a range in which discharging occurs between the electrodes.

Further, by also feeding an electric power (output density) of 1 W/cm² or more to the first electrode (the first high-frequency electric filed), it becomes possible to increase the output density while maintaining the uniformity of the second high-frequency electric field. With this, it is possible to produce plasma with more uniform and high density. As a result, it becomes possible to satisfy both to increase the film production rate and to improve film quality. The electric power is preferably 5 W/cm² or more. The upper limit of the electric power fed to the first electrode is preferably 50 W/cm².

Here, the waveform of a high-frequency electric field is not particularly limited. The waveform includes a sine wave continuous oscillation mode called a continuous mode and an intermittent oscillation mode called a pulse mode which conducts ON and OFF intermittently. Any one of them may be employed. However, it is preferable that a continuous sine wave is applied at least for the second electrode side (the second high-frequency electric field), because a dense and high quality film can be obtained.

An electrode employed in a thin film forming method with such atmospheric pressure plasma is required to endure for severe conditions in terms of structure and performance. As such an electrode, an electrode in which a dielectric substance is covered on a metallic base material is preferable.

In the electrode covered with a dielectric substance employed in the present invention, it is preferable to combine various metallic base materials with dielectric substances such that the characteristics of a combined metallic base material match with those of a combined dielectric substance. One of these characteristics is a linear thermal expansion coefficient, that is, a metallic base material and a dielectric substance are combined such that a difference in linear thermal expansion coefficient between them becomes 10×10⁻⁶/° C. or less. The difference is preferably 8×10⁻⁶/° C. or less, more preferably 5×10⁻⁶/° C. or less, and most preferably 2×10⁻⁶/° C. or less. The term “linear thermal expansion coefficient” is a well-known physical property value peculiar to materials.

There are the following combinations of electrically conductive metallic base materials and dielectric substances with which a difference of linear thermal expansion coefficient becomes within the above ranges.

1: the metallic base material is pure titanium or a titanium alloy, and the dielectric substance is a thermally sprayed ceramics film.
2: the metallic base material is pure titanium or a titanium alloy, and the dielectric substance is a glass lining.
3: the metallic base material is stainless steel, and the dielectric substance is a thermally sprayed ceramics film.
4: the metallic base material is stainless steel, while the dielectric substance is a glass lining.
5: the metallic base material is a composite material of ceramics and iron, and the dielectric substance is a thermally sprayed film.
6: the metallic base material is a composite material of ceramics and iron, and the dielectric substance is a glass lining.
7: the metallic base material is a composite material of ceramics and aluminum, and the dielectric substance is a thermally sprayed film.
8: the metallic base material is a composite material of ceramics and aluminum, and the dielectric substance is a glass lining.

From the viewpoint of a difference in the linear thermal expansion coefficient, the above items 1, 2, and 5 to 8 are preferable, and item 1 is particularly preferable.

In the present invention, in view of the above characteristics, titanium or titanium alloys are particularly useful as a metallic base material. The employment of titanium or titanium alloys as the metallic base material and the employment of the above dielectric substances can reduce degradation of electrodes during use, particularly such as cracking, peeling, or releasing, therefore the resultant electrode can endure for a long term service under severe conditions.

The metallic base materials of the electrodes which are useful in the present invention are titanium alloys containing 70% by weight or more of titanium or metal titanium. In the present invention, when the content of titanium in titanium alloys or titanium metals is 70% by weight or more, they may be employed without any problem. However, those containing 80% by weight or more of titanium are preferable. As titanium alloys or titanium metals useful in the present invention, employed may be those which are commonly employed as industrial pure titanium, corrosion resistant titanium, or high-strength titanium. Examples of industrial pure titanium include TIA, TIB, TIC, and TID. Any of those slightly contains iron atoms, carbon atoms, nitrogen atoms, oxygen atoms and hydrogen atoms, and contains 99% by weight or more of titanium. T15PB is preferably employed as the corrosion resistant titanium alloys, contains lead in addition to the above contained atoms, and contains 98% by weight or more of titanium. Further, T64, T325, T525 and TA3 are preferably employed as a titanium alloy, contain aluminum, vanadium, or tin in addition to the above atoms except lead, and contain 85% by weight or more of titanium. These titanium alloys and metal titanium have a thermal expansion coefficient as low as about one half of that of stainless steel, such as AISI316. Therefore, they have a good combination with the below-described dielectric substance provided onto a titanium alloy or titanium metal as a metallic base material. As a result, the resultant electrode can endure for a long term service under severe conditions.

On the other hand, as a characteristic specifically required for dielectric substances, the dielectric substances are inorganic compounds with a relative permittivity of 6 to 45. Examples of such dielectric substances include: alumina, ceramics such as silicon nitride, and glass lining materials such as silicate based glass and borate based glass. Among them, preferable are those provided with thermally sprayed ceramics and those provided with lined glass. Specifically, a dielectric substance provided with thermally sprayed alumina is preferable.

Further, as one of the specifications which endures high electric power as described above, the void ratio of dielectric substances is 10% by volume or less, preferably 8% by volume or less, and more preferably more than 0% by volume and 5% by volume or less. It is possible to measure the void ratio of dielectric substances by the BET adsorption method and the mercury porosimeter. In the example described below, the void ratio is measured by the use of a broken piece of the dielectric substance covered on a metallic base material by the mercury porosimeter manufactured by Shimadzu Corporation. A low void ratio of dielectric substances achieves higher durability. As such dielectric substances having a low void ratio as well as voids, employed is a ceramics thermally sprayed film which has a high density and high adhesion and is prepared by the atmospheric plasma thermal spraying method described below. In order to further reduce the void ratio, it is preferable to conduct a pore sealing process.

The above atmospheric plasma thermal spraying method employs techniques such that fine powders such as ceramics or wires are placed in a plasma heat source, made to minute particles in a molten or semi-molten state, and then sprayed onto a metallic base material so as to form a film. The term “Plasma heat source” refers to a high temperature plasma gas prepared in such a way that a molecular gas is heated to high temperature to dissociate into atoms and the dissociated atoms are provided with energy to release electrons. The jetting speed of the above plasma gas is high, and thermal spraying materials collide with a metallic base material at a high speed as compared with the conventional arc thermal spraying or flame thermal spraying. Therefore, it is possible to prepare a film with high adhesion strength and high density. More details are referred to “a thermal spraying method to form a heat shielding film on a member exposed to high temperature” described in JP-A No. 2000-301655. With this method, it is possible to obtain the void ratio of the dielectric substances (ceramic thermal sprayed film) which are covered as described above.

Further, another preferable specification to endure high electric power is that the thickness of dielectric substances is 0.5 to 2 mm. The variation of the above thickness is desirably 5% or less, preferably 3% or less, and is more preferably 1% or less.

In order to further reduce the void ratio of dielectric substances, it is preferable that the abovementioned thermal sprayed films such as ceramics are subjected to a pore sealing treatment with inorganic compounds. Metal oxides are preferable as the above inorganic compounds, and among the metal oxides, those which contain silicon oxide (SiOₓ) as a main component are particularly preferable.

The inorganic compounds for the pore sealing treatment are preferably those which are formed by being hardened with a sol-gel reaction. When the inorganic compounds for the pore sealing treatment are composed of metal oxides as a main component, the above ceramic thermal sprayed film is coated with metal alkoxides and the like as a pore sealing liquid and is hardened with the sol-gel reaction. When the inorganic compounds are composed of silica as a main component, it is preferable to employ alkoxysilane as the pore sealing liquid.

In order to accelerate the sol-gel reaction, it is preferable to employ an energy treatment. The energy treatments include thermal hardening (preferably 200° C. or less) as well as ultraviolet ray exposure. Further, as the procedure of the pore sealing treatment, if a pore sealing liquid is diluted and coating and hardening are repeated several times, inorganic nature is further enhanced, whereby a dense electrode with no deterioration can be obtained.

When a sealing treatment is conducted in such a way that the ceramics thermal sprayed film of the dielectric substance-covered electrode is coated with a pore sealing liquid such as metal alkoxide and then hardened with the sol-gel reaction, the content of metal oxides after the hardening is preferably 60 mol % or more. When alkoxysilane is employed as the metal alkoxide of the pore sealing liquid, the content of SiOₓ (x is 2 or less) after the hardening is preferably 60 mol % or more. The content of SiOₓ after the hardening is measured by the analysis of a cross section of a dielectric substance layer with XPS (X-ray photoelectron spectroscopy).

In the electrode according to the thin film forming method of the present invention, from the viewpoint of obtaining the effects described in the present invention, it is preferable that the maximum height (Rₘₐₓ) of the surface roughness specified by JIS B 0601 at least at the side of the electrode coming in contact with the base material, is regulated to be 10 μm or less. The maximum value of the surface roughness is regulated to more preferably 8 μm or less, and specifically preferably 7 μm or less. With a method of polishing and finishing the surface of the dielectric substance of the dielectric substance covered electrode to the above condition, it becomes possible to maintain a predetermined thickness of a dielectric substance and a predetermined gap between the electrodes. As a result, it becomes possible to stabilize the electric discharge state, to minimize distortion and cracking due to difference in thermal contraction and residual stress, and to enhance high accuracy and durability greatly. It is preferable that the polishing and finishing of the dielectric substance surface is conducted at least at the side of the dielectric substance which comes in contact with the base material. Further, the center line mean surface roughness (Ra), specified by JIS B 0601, is preferably 0.5 μm or less, and is more preferably 0.1 μm or less.

In the dielectric substance covered electrode employed in the present invention, another preferable specification to endure high power is that heatproof temperature is 100° C. or more. The heatproof temperature is more preferably 120° C. or more, and is specifically preferably 150° C. or more, however the upper limit is 500° C. The term “heatproof temperature” refers to the highest temperature at which the dielectric substance covered electrode can endure on the condition capable of discharging normally without causing insulation breakdown at the voltage employed in the atmospheric pressure plasma processing. It becomes possible to attain such heatproof temperature with an appropriate combination of the above thermal spraying of ceramic, the application of dielectrics substance provided by the lining of glass layers different in bubble mixing amount, and a technique to appropriately select a metallic base material and a dielectric substance in which difference in linear heat expansion coefficient between them is in the above range.

In the present invention, a ceramic layer is preferably formed by a thin film forming method which feeds a gas containing a thin film forming gas and a discharge gas in a discharge space under an atmospheric pressure or a pressure in the vicinity of the atmospheric pressure; applies a high frequency electric field in the discharge space so as to excite the gas; and exposes to the excited gas so as to form a thin film.

Further, it is preferable that the discharge gas is a nitrogen gas; a first high frequency electric field and a second high frequency electric field are superimposed in the high frequency electric field applied in the discharge space; a frequency cot of the second high frequency electric field is higher than a frequency col of the first high frequency electric field; a relation among the intensity VI of the first high frequency electric field, the intensity V2 of the second high frequency electric field, and the intensity IV of a discharge starting electric field satisfies a relationship of (V1≧IV>V2 or V1>IV≧V2); and the output density of the second high frequency electric field is 1 W/cm² or more.

### <<Use of a Liner>>

In the base material in which a ceramic layer is formed on its one side, at the time of providing a polymer layer, a low refractive index ceramic layer and further a layer (i.e., a heat ray reflecting layer in which a metal layer, such as Al, a dielectric substance layer, an Ag (or alloy) layer, and a dielectric substance layer are sequentially laminated) on its reverse surface, a mold releasable resin material may be provided in order to prevent the ceramic layer having been provided already from being flawed or covered with foreign materials.

When a resin material having a mold releasing ability is laminated on the ceramic layer formed on the resin base material, the ceramic layer is prevented from being flawed by a contacting roller and covered with foreign materials, further, rollers coming in direct contact with a surface to be subjected to a plasma treatment are minimized. Accordingly, when flaws or foreign materials taking place on a ceramic layer are reduced as far as possible, a weather resistance resin base material provided with the ceramic layer excellent in gas barrier properties can be produced in high yield. Therefore, in the case of providing a ceramic layer having barrier properties on both sides of a resin base material, it is preferable to laminate a resin material on the creaming layer.

### <<Resin Material Having a Mold-Releasing Ability>>

In the production method of a weather resistance resin base material of the present invention having gas barrier properties, after a ceramic layer has been formed on one surface side (A surface), before another ceramic layer is formed on a reverse surface side (B surface), it is preferable to laminate a resin material having a mold-release ability on the ceramic layer having been already formed on the A surface.

Although the resin material having a mold-release ability and used in the present invention is not limited specifically, it may be preferable that the resin material is composed of at least a film and a sticky agent layer which is formed on one side of the film and includes a sticky agent, the sticky agent is at least one kind selected from an acrylic type sticky agent, a silicon type sticky agent and a rubber type sticky agent, and the sticky force of the sticky agent is preferably 1 mN/cm or more and 2 N/cm or less, and more preferably 1 mN/cm or more and 200 mN/cm or less.

If the sticky force of the sticky agent is 1 mN/cm or more, a sufficient close contact force between the resin material and the ceramic layer can be obtained. Accordingly, peel-off during continuous conveyance does not occur and the ceramic layer having been already formed can be prevented from being influenced due to the contact with rollers during conveyance. Further, if the sticky force is 2 N/cm or less, when the resin material is peeled off, since an excessive force is not applied on the ceramic layer, the breakage of the ceramic layer and the remaining of the sticky agent on the ceramic layer are not caused.

The sticky force of a sticky agent is obtained in such a way that Corning 1737 is used as a test plate in accordance with the measuring method based on JIS Z 0237, a resin material is brought in pressure contact with the test plate, and a sticky force is measured 20 minutes after the pressure contact.

Further, the thickness of a sticky agent is preferably 0.1 μm or more and 30 μm or less. When the thickness of a sticky agent is preferably 0.1 μm or more, a sufficient close contact force between the resin material and the resin base material can be obtained. Accordingly, peel-off during continuous conveyance does not occur and the ceramic layer having been already formed can be prevented from being influenced due to the contact with rollers during conveyance. Further, when the thickness of a sticky agent is preferably 30 μm or less, when the resin material is peeled oft since an excessive force is not applied on the ceramic layer, the breakage of the ceramic layer and the remaining of the sticky agent on the ceramic layer are not caused.

Further, the weight average molecular weight of the sticky agent which constitutes the sticky layer is desirably 400,000 or more and 1,400,000 or less. If the weight average molecular weight is 400,000 or more, the does not become excessive, and If the weight average molecular weight is 1,400,000 or less, a sufficient sticky force can be obtained. If the weight average molecular weight is made in the above range, the remaining of the sticky agent on the ceramic layer can be prevented. Further, since heat and energy are applied at the time of forming a ceramic layer by the plasma treatment, if the sticky agent has not a proper weight average molecular weight, there is fear that the sticking material causes transfer or peel-off.

Next, each structure material of the resin material which has a mold-releasing ability is explained.

The resin material having a mold-releasing ability and used in the present invention is mainly composed of a base material, a sticky layer formed on one side of the base material, and a releasing layer laminated on a surface of the sticky layer, that is, the surface opposite to the base material.

### (Base Material)

Examples of a base material used for the resin material according to the present invention, include, without being limited thereto, plastic films, for example, polyolefin type films, such as a polyethylene film and a polypropylene film; polyester films, such as polyethylene terephthalate, polybutylene terephthalate; polyamide type films, such as a hexamethylene adipamide and the like; halogen-containing type films, such as polyvinyl chloride, poly vinylidene chloride and poly fluoro ethylene; vinyl acetate and its derivative films, such as polyvinyl acetate, polyvinyl alcohol, and an ethylene vinyl acetate copolymer, and such a plastic films is preferable, because it does not cause microscopic dust, differing from paper. In the present invention, from the viewpoints of heat resistance properties and easy availability, a polyethylene terephthalate film is preferably used.

Although the thickness of a base material is not limited specifically, a base material with a thickness of 10 μm to 300 μm may be used. Preferably, the thickness is 25 μm to 150 μm. If the thickness is 10 μm or less, since the film is thin, it may be difficult to handle the film. On the other hand, If the thickness is 300 μm or more, since the film becomes hard, a conveyance ability and a close contact ability with a roller worsen.

### <Sticky Layer>

In the present invention, examples of the types of sticky agents includes, without being limited thereto, a rubber type sticky agent, an acryl type sticky agent, a urethane type sticky agent, a silicone type sticky agent, and a ultraviolet hardening type sticky agent. At least one type selected from an acryl type sticky agent, a silicone type sticky agent and a rubber type sticky agent is preferably employable.

### <Acryl Type Sticky Agent>

A homopolymer of (meth)acrylic acid ester or a copolymer of (meth)acrylic acid ester with other copolymeric monomers is used as the acryl type sticky agent. Further, examples of a monomer constituting these copolymers or a copolymeric monomer includes alkyl ester of (meth)acrylic acid (e.g. methyl ester, ethyl ester, butyl ester, 2-ethylhexyl ester, octyl ester and isononyl ester), hydroxyalkyl ester of (meth)acrylic acid (e.g. hydroxyethyl ester, hydroxybutyl ester, and hydroxyhexyl ester), glycidyl ester (meth)acrylate, (meth)acrylic acid, itaconic acid, maleic anhydride, amide (meth)acrylate, N-hydroxymethylamide (meth)acrylate, alkylaminoalkyl ester (meth)acrylate (e.g. dimethylaminoethyl, methacrylate, and t-butylaminoethyl methacrylate), vinyl acetate, styrene, and acrylonitrile. Acrylic acid alkyl ester whose homopolymer has a glass transition temperature of −50° C. or less is normally used as a monomer as a major component.

Isocyanate, epoxy, allysine based hardening agents can be used as the hardening agent of the acryl type sticky agent. The aromatic agent such as toluylene diisocyanate (TDI) is preferably used as the isocyanate hardening agent because stable sticky agent strength is exhibited even after long-term storage and a harder sticky agent layer can be provided. Further, this sticky agent can contain stabilizer, ultraviolet absorber, flame retardant and antistatic agent as an additive.

To add re-separability and to keep low and stable sticky force, it is possible to add the component containing a lower surface energy such as organic resin including wax, silicone, and fluorine to the extent that the components does not migrate to the counterpart base material. For example, the organic resin such as wax, higher fatty acid ester and low-molecular phthalic acid ester can be used.

### <Rubber Type Sticky Agent>

As the rubber type sticky agent, employable is polyisobutylene rubber, butyl rubber, and their mixture. Further, employable is these rubber type sticky agents blended with a stickiness providing agent, such as abietic acid rosin ester, terpene/phenol copolymer, and terpene/indene copolymer.

The base polymer of the rubber type sticky agent is exemplified by naturally-occurring rubber, isoprene rubber, styrene-butadiene rubber, reclaimed rubber, and polyisobutylene rubber. It also includes styrene-isoprene-styrene rubber, and styrene-butadiene-styrene rubber.

Of the aforementioned substances, the block rubber type sticky agent is exemplified by the tacky producer and softener mixed with the block copolymer expressed by the general formula of A-B-A and the block copolymer expressed by the general formula of A-B (wherein “A” denotes a styrene polymer block and “B” indicates the butadiene polymer block, isoprene polymer block, or olefin polymer obtained by their hydrogenation; hereinafter referred to as “styrene thermoplastic elastomer”), the aforementioned block copolymer being used as a major component.

In the aforementioned block rubber sticky agent, the styrene polymer block A is preferable to have an average molecular weight of 4,000 through 120,000, or more preferably 10,000 through 60,000. The styrene polymer block A is preferable to have a glass-transition temperature of 15° C. or more. Further, the butadiene polymer block, isoprene polymer block or olefin polymer block B obtained by their hydrogenation is preferable to have an average molecular weight of 30,000 through 400,000, or more preferably 60,000 through 200,000. It is preferable that they has a glass-transition temperature of −15° C. or less. The mass ratio between the aforementioned components A and B is preferably A/B=5/95 through 50/50, more preferably A/B=10/90 through 30/70. If the A/B value has exceeded 50/50, the elastomeric properties of the polymer at the normal temperature will be reduced and stickiness does not easily occur. If it is less than 5/95, the styrene domain will be loose and cohesion will be insufficient. Further, required sticky force cannot be obtained, and the sticky agent layer will be broken at the time of separation. Such problems arise.

Further, the addition of polyolefin based resin to the aforementioned sticky agent improves the property of release from the separate paper or separation film. The polyolefin resin is exemplified by low-density polyethylene, intermediate-density polyethylene, high-density polyethylene, linear low-density polyethylene, ethylene-α olefin copolymer, propylene-α olefin copolymer, ethylene-ethylacrylate copolymer, ethylene-vinyl acetate copolymer, ethylene-methylmethacrylate copolymer, ethylene-n-butylacrylate copolymer and their mixture.

This polyolefin resin is preferable to have smaller low molecular weight. To put it more specifically, the low molecular weight extracted by carbonization at boiling point using n-pentane is preferably less than 1.0% by mass. If the low molecular weight exceeds 1.0% by mass, this low molecular weight will have an adverse effect on the sticking properties in response to the temperature or secular changes, with the result that the sticky force will be reduced.

When silicone oil is added to the aforementioned sticky agent, it is possible to further reduce the affinity with the back surface provided with the coating film mainly made up of polyvinyl alcohol. This silicone oil is a high molecular compound having a polyalkoxy siloxane chain as a principal chain. It has a function of controlling the sticky force of the sticky agent and discouraging increasing adhesion, in order to improve the hydrophobicity of the sticky agent layer and to cause bleeding on the interface of adhesion, namely, on the surface of the sticky agent layer. The molecular weight of the silicone oil is preferably 1,000 through 100,000, more preferably 10,000 through

In the present invention, a sticky agent layer is formed through crosslinking by adding a crosslinking agent to the aforementioned sticky agent.

The crosslinking agent used for crosslinking of the natural rubber type sticky agent includes sulfur, vulcanization assistant and vulcanization accelerating agent (typically represented by dibutylthiocarbide zinc). Polyisocyanate and related substances are used as a crosslinking agent capable of causing crosslinking of the sticky agent made up mainly of natural rubber and carboxylate copolymer polyisoprene, at a room temperature. A polyalkyl phenol resin is used as the crosslinking agent characterized by excellent heat resistance and high resistance to contamination, in order to crosslink the butyl rubber and natural rubber. The organic peroxide exemplified by benzoyl peroxide and dicumyl peroxide can be used to crosslink the sticky agent made of butadiene rubber and natural rubber. This provides a sticky agent characterized by high resistance to contamination. The multifunctional methacryl ester is used as a crosslinking assistant. In addition, the sticky agent can be formed by ultraviolet crosslinking or electronic crosslinking.

### <Silicone Type Sticky Agent>

In the sticky agent layer of the present invention, addition reaction hardening type silicone sticky agent and polymerization hardening type silicone sticky agent is available as a silicone sticky agent. The addition reaction hardening type silicone sticky agent is preferably used in the present invention.

The following compositions are preferably used for the addition reaction hardening type silicone sticky layer coating liquid:

(A) Polydiorganosiloxane with two or more alkenyl groups contained in one molecule
(B) Polyorganosiloxane containing SiH group

### (C) Inhibitor

(D) Platinum catalyst
(E) Conductive fine particulate

Here the component (A) is a polydiorganosiloxane with two or more alkenyl groups contained in one molecule. The polydiorganosiloxane with alkenyl groups can be exemplified by the substance expressed by the following formula (1).

R₍₃₋ₐ₎XₐSiO—(RXSiO)ₘ—(R₂SiO)ₙ—(RXSiO)ₚ—R₍₃₋ₐ₎XaSiO General formula (1)

In the general formula (1), R denotes the monovalent hydrocarbon having a carbon number of 1 through 10, and X denotes an organic group containing alkenyl group. “a” indicates an integer ranging from 0 through 3, and 1 is preferable. “m” indicates 0 or more. Therefore, if a=0, m is 2 or more. “m” and “n” each satisfy the equation 100≦m+n≦20,000, and “p” denotes 2 or more.

“R” denotes the monovalent hydrocarbon having a carbon number of 1 through 10. To put it more specifically, it includes alkyl group such as methyl group, ethyl group, propyl group and butyl group; cycloalkyl group such as cyclohexyl group; and aryl group such as phenyl group and tolyl group. Especially methyl and phenyl groups are preferably used.

The “X” denotes an organic group containing alkenyl group. It preferably contains a carbon number of 2 through 10. To put it more specifically, it includes vinyl group, aryl group, hexenyl group, octenyl group, acryloylpropyl group, acryloylmethyl group, methacryloyl propyl group, cyclohexenylethyl group and vinyloxypropyl group. Especially vinyl and hexenyl groups are preferable.

The polydiorganosiloxane is only required to have oil- and raw rubber-like properties. The component (A) preferably has a viscosity of 100 mPa·s or more at 25° C. It more preferably has a viscosity of 1000 mPa·s or more. The upper limit is not particularly restricted. To ensure easier blending with other components, it is preferable to select the viscosity so that the degree of polymerization will be 20,000 or less. One type of the component (A) can be used independently. Alternatively, two or more types can be used in combination.

The polyorganosiloxane containing the SiH as a component (B) is a crosslinking agent. It is possible to use the organohydropolysiloxane containing at least two hydrogen atoms bonded with silicon atom, preferably three hydrogen atoms, in one molecule, wherein this organohydropolysiloxane is shaped in a straight chain, or in a branched or cyclic form.

The component (B) includes the compounds expressed by the following general formula (2), without being restricted thereto.

H_{b}R¹_{(3-b)}SiO—(HR¹SiO)ₓ—(R¹₂SiO)_{Y}SiR¹_{3-b)}H_{b} General formula (2)

In the general formula (2), “R¹” denotes the monovalent hydrocarbon having a carbon number of 1 through 6 that does not contain an aliphatic unsaturated bond. “b” indicates an integer from 0 through 3, and “x” and “y” each denote integers. They show the numbers where the viscosity of this organohydropolysiloxane at 25° C. is 1 through 5,000 mPa·s.

The viscosity of this organohydropolysiloxane at 25° C. is preferably 1 through 5,000 mPa·s, more preferably 5 through 1,000 mPa·s. A mixture of two or more types can be used.

Crosslinking by addition reaction occurs between the component (A) and component (B). The gel fraction of the sticky layer subsequent to hardening depends on the percentage of crosslinking components. The amount of component (B) to be used is preferably determined in such a manner that the mole ratio of the SiH group in the component (B) relative to the alkenyl group in the component (A) will be 0.5 through 20, more preferably 0.8 through 15. If this value is less than 0.5, crosslinking density will be reduced. This will result in poorer retaining capacity. If the value is more than 20, the sticky force and tackiness will be reduced. This will reduce the time when the processing solution is available in some cases.

To improve the heat resistance such as heat retaining capacity and the resistance to solvent such as control of the solvent penetration, the percentage of the crosslinking component in the composition should be increased. However, this is increased excessively, the sticky force or film flexibility will be reduced in some cases. To overcome such difficulties, the blending ratio of the components (A)/(B) in terms of mass is preferably 20/80 through 80/20, more preferably 45/55 through 70/30. If the blending ratio of the component (A) is less than 20/80, sticking properties such as sticky force and tackiness will be reduced. Further, if it is more than 80/20, sufficient heat resistance cannot be ensured.

The component (C) is an addition reaction inhibitor. It is added to ensure that the processing solution will not be thickened or gelated prior to heating or hardening, when the silicone sticky layer coating liquid are blended and are coated on the base material.

Specific examples of the component (C) include:
3-methyl-1-butyne-3-ol
3-methyl-1-pentine-3-ol
3,5-dimethyl-1-hexyne-3-ol
1-ethynylcyclohexanol
3-methyl-3-trimethylcyloxy-1-butyne
3-methyl-3-trimethylcyloxy-1-pentine
3,5-dimethyl-3-trimethylcyloxy-1-hexyne
1-ethynyl-1-trimethylcyloxycyclohexane
bis(2,2-dimethyl-3-butynoxy)dimethylsilane
1,3,5,7-tetramethyl-1,3,5,7-tetravinylcyclotetrasiloxane, and
1,1,3,3-tetramethyl-1,3-divinyldisiloxane.

The amount of the component (C) used in blending is preferably 0 through 0.5 parts by mass, more preferably 0.05 through 2.0, with respect to 100 parts by mass of the total of the components (A) and (B). If the value exceeds 5.0 parts by mass, hardening property will be reduced.

The component (D) is a platinum catalyst. It includes platinic acid chloride, alcohol solution of platinic acid chloride, reaction product between platinic acid chloride and alcohol, reaction product between platinic acid chloride and olefin compounds, and reaction product between platinic acid chloride and siloxane containing vinyl group.

The additive amount of the component (D) as platinum is preferably 1 to 5,000 ppm, more preferably 5 to 2,000 ppm, relative to the total amount of the compounds (A) and (B). If this value is less than 1 ppm, hardening efficiency, crosslinking density and retaining capacity will be reduced in some cases. If the value exceeds 5,000 ppm, it will reduce the time when the processing solution is available, in some cases.

There is no special restriction on the form of the conductive fine particle of component (E). The conductive fine particle can be spherical, branched or needle-shaped. Similarly, the particle diameter is not restricted. It is preferable that the maximum particle diameter should not exceed 1.5 times the thickness of the coating. If it exceeds this value, excessively large protrusions of the conductive fine particles will be produced on the surface of the coating of sticky agent. These portions tend cause uplifting from the coated member.

Into the sticky layer, various additives may be added. For example, a cross linking agent, a catalyst, a plasticizer, an antioxidant, a colorant, an antistatic agent, a bulking agent, a stickiness providing agent, a surface active agent, and the like may be added.

A coating method of the sticky layer on the base material may be conducted by a roll coater, a blade coater, a bar coater, an air knife coater, a gravure coater, a reverse coater, a die coater, a lip coater, a spray coater, a comma coater and others. If required, smoothing, drying, heating and exposure to electronic rays such as ultraviolet rays are carried out, whereby a sticky layer is formed.

### <Releasing Layer>

As raw materials used as a releasing layer, a plastic film may be preferable, because it does not cause dust. Examples of a plastic film used as the releasing layer of the present invention, include, without being limited thereto, polyolefin type films, such as a polyethylene film and a polypropylene film; polyester films, such as polyethylene terephthalate, polybutylene terephthalate; polyamide type films, such as a hexamethylene adipamide and the like; halogen-containing type films, such as polyvinyl chloride, poly vinylidene chloride and poly fluoro ethylene; vinyl acetate and its derivative films, such as polyvinyl acetate, polyvinyl alcohol, and an ethylene vinyl acetate copolymer. A preferable film is polyester films, for example, a polyethylene terephthalate film, because it has proper elasticity. The plastic film used for the releasing layer may be coated with a releasing agent. Specific examples of a coating liquid to apply a mold releasing treatment, include, in DEHESIVE series of Asahi Kasei Wacker Silicone Co., 636, 919, 920, 921 and 924 as a non-solvent type coating liquid, 929, 430, 440, 39005 and 39006 as an emulsion type coating liquid, and 940, 942, 952, 953 and 811 as a solvent type coating liquid Ltd.; and silicone for releasing paper manufactured by GE Toshiba Silicone Co., Ltd., such as TPR6500, TPR6501, UV9300, UV9315, XS56-A2775, XS56-A2982, TPR6600, TPR6605, TPR6604, TPR6705, TPR6722, TPR6721, TPR6702, XS56-B3884, XS56-A8012, XS56-B2654, TPR6700, TPR6701, TPR6707, TPR6710, TPR6712, XS56-A3969, XS56-A3075, and YSR3022.

### <<Polymer Layer>>

In the present invention, it is preferable to provide a polymer layer between a resin base material and the above ceramic layer, and the polymer layer contains preferably a light stabilizer.

In order to enhance abrasion resistant, it is preferable to provide the polymer layer on the ceramic layer.

In the present invention, it is preferable that these polymer layers include a light hardening resin or thermo-hardening resin as a main component.

### (Multifunctional Acrylate)

Generally, the polymer film (layer) including a light hardening resin or thereto hardening resin as a main component is composed of active light, such as UV rays, hardening resin, and multifunctional acrylate is desirable. The multifunctional acrylate is preferably selected from a group consisting of a pentaerythritol multifunctional acrylate, a dipenta erythritol multifunctional acrylate, a pentaerythritol multifunctional methacrylate, and a dipenta erythritol multifunctional methacrylate. Here, the multifunctional acrylate is a compound which has two or more acryloyl oxy groups and/or methacryloyl oxy groups in the molecule. Examples of a monomer of the multifunctional acrylate include, for example, ethylene glycol diacrylate, diethylene glycol diacrylate, 1,6-hexanediol diacrylate, neopentylglycol diacrylate, trimethylolpropane triacrylate, trimethylolethane triacrylate, tetramethylolmethane triacrylate, tetramethylolmethane tetraacrylate, and the like. These compounds may be used solely respectively, or as a mixture of two or more kids. Further, the compound may be oligomers, such as a dimer or trimer of the above-mentioned monomers.

The additive amount of the active light hardening resin is preferably 15 mass % or more and less than 70 mass % in the solid content in the polymer layer forming composition.

Further, the polymer layer preferably contains a photopolymerization initiator. As an amount of the photopolymerization initiator, it is preferable that, in mass ratio, photopolymerization initiator:active light hardening resin=20:100 to 0.01:100.

Specific examples of the photopolymerization initiator, include, without being limited thereto, acetophenone, benzophenone, hydroxybenzophenone, mihiler ketone, α-amiroxim ester, and thio xanthone, and these derivatives.

In the polymer layer, binders, such as hydrophilic resins used for an intermediate layer, i.e., a thermoplastic resin, a thereto-hardening resin, or gelatin, can also be used by being mixed with the above-mentioned active light hardening resin. Further, in order to adjust flaw resistance, a slipping ability and a refractive index, the polymer layer may contain particles of inorganic compounds, such as a silicon oxide, or organic compounds.

In the present invention, in the polymer layer, an antioxidant which does not inhibit a light hardening reaction may be used. As the antioxidant, a hindered phenol derivative, a thio propionic acid derivative, a phosphite derivative, etc. can be employed. Specific examples of the antioxidant, include, for example, 4,4′-thiobis (6-tert-3-methyl phenol), 4,4′-butylidenebis(6-tert-butyl-3-methyl phenol), 1,3,5-tris(3,5-di-tert-butyl-4-hydroxybenzyl) isocyanurate, 2,4,6-tris(3,5-di-tert-butyl-4-hydroxybenzyl) mesitylene, di-octadecyl-4-hydroxy-3,5-di-tert-butyl benzyl phosphate.

These polymer layers may be coated by well-known methods, such as a gravure coater, a dip coater, a reverse coater, a wire bar coater, a die coater, and an ink jet method. After the coating, a coating layer is dried with heating and subjected to a UV ray hardening process. The thickness of the polymer layer is preferably 1 to 20 μm, and more preferably 3 to 10 μm.

The polymer layer forming composition may contain solvent, and may contain the solvent appropriately if needed so as to be diluted with it. An organic solvent contained in a coating liquid may be selected appropriately from, for example, hydrocarbons (toluene, xylene); alcohols (methanol, ethanol, isopropanol, butanol, cyclohexanol); ketones (acetone, methyl ethyl ketone, methyl isobutyl ketone), esters (methyl acetate, ethyl acetate, methyl lactate), glycol ethers, and other organic solvents, or the selected solvents can be used as a mixed solvent. It may be desirable to use the above solvents which contain 5 mass % or more, more preferably 5 to 80 mass % of propylene glycol mono-alkyl ether (1 to 4 carbon atoms of an alkyl group) or propylene glycol mono-alkyl ether acetate (1 to 4 carbon atoms of an alkyl group).

It is preferable to add these components in a range of 0.01 to 3 mass % to the solid content in the coating liquid.

After coating and drying, the polymer layer may be irradiated with UV rays. A irradiation time to obtain a necessary irradiation amount of active light rays may be about 0.1 seconds to one minute, and from the viewpoint of the hardening efficiency of a UV ray hardening resin or working efficiency, 0.1 to 10 seconds may be preferable.

Further, the illumination intensity of these active light irradiating sections is preferably 0.05 to 0.2 W/m².

Further, the polymer layer according to the present invention which contains a light hardening or thermo hardening resin as a main component, preferably contains the abovementioned light stabilizer.

### <<Weather Resistance Resin Base Material>>

FIG. 1 is a cross-sectional structural diagram showing the structures of weather resistance resin base materials (1) to (5) of the present invention and comparative weather resistance resin base materials (6) and (7). (1) is a weather resistance resin base material which has a ceramic layer 2 on a resin base material 3 in which a polymer layer is provided on one surface of a resin film 1 containing a light stabilizer 4. (2) is a weather resistance resin base material which has a ceramic layer 2 on a resin base material 3 in which a polymer layer containing a light stabilizer 4 is provided on one surface of a resin film 1 containing a light stabilizer 4. (2) is a weather resistance resin base material which has a ceramic layer 2 on a resin base material 3 in which a polymer layer containing a light stabilizer 4 is provided on one surface of a resin film 1. (4) is a weather resistance resin base material in which a polymer layer 5 and a creaming layer 2 are provided on the side of the resin base material 3 where the ceramic layer 2 does not exist in the weather resistance resin base material of (2). (5) is a weather resistance resin base material in which a polymer layer containing a light stabilizer 4 and a ceramic layer are provided on both surfaces of a resin film 1 and a polymer layer 5 is further provided on one side. (6) is a weather resistance resin base material in which a polymer layer 5 containing a light stabilizer 4 is provided on one surface of a resin film 1 containing a light stabilizer 4. (7) is a weather resistance resin base material which has a creaming layer on a resin base material 3 in which a polymer layer 5 is provided on one surface of a resin film 1.

The weather resistance resin base material of the present invention has a moisture vapor transmission rate (JIS K7129-1992 B method, under the condition of 40° C., and 90% RH) of 0.01 g/(m²·24 h) or less. The rate is preferably 1×10⁻³ g/(m²·24 h) or less, more preferably 1×10⁻⁵ g/(m²·24 h) or less. The moisture vapor transmission rate can be measured by the use of a moisture vapor transmission rate measuring apparatus PERMATRAN-W3/33MG module manufactured by MOCON Corporation.

### <<Optical Element>>

The weather resistance resin base material produced by the present invention can be applicable to a wide range of areas. For examples, the weather resistance resin base material is used for overlay films for the purpose of surface protection, gloss enhancement and discoloration and deterioration prevention for a marking film used by being pasted on the surface of railway vehicles, cars, automatic vending machines and the like, or for films used mainly for the purpose of weather resistance enhancement as base materials for a surface protective film of an exterior signboard; an antireflection film of a liquid crystal display; a backseat for a solar battery; a film for an electronic paper sheet; an electromagnetic wave shielding film for a plasma display; a film for organic electroluminescence; a film to be pasted on a window (such as a heat ray reflecting film which is pasted on windows of facilities exposed to sunlight for a long time, such as outdoor windows of building and car windows so as to provide a heat ray reflecting effect); a base material of a reflective board; a base material of a light collecting boar; a film for a vinyl house for agriculture; and the like. Specifically, the weather resistance resin base material is suitable for optical elements which are used under an environment where the optical elements are exposed to UV rays, and whose functions are spoiled greatly by the reasons that the optical functions of the base material, for example, transmittance, reflectance, haze, color tone and mechanical strength are changed by being exposed to UV rays. Concrete examples include optical elements such as an antireflection film of a liquid crystal display, a backseat for a solar battery; a film for an electronic paper sheet; an electromagnetic wave shielding film for a plasma display; a film for organic electroluminescence; base materials of films to be pasted on a window such as a heat ray reflecting film which is pasted on windows of facilities exposed to sunlight for a long time, for example, outdoor windows of building and car windows, so as to provide a heat ray reflecting effect; a base material of a reflective board; a film for a vinyl house for agriculture; and the like. Further, the weather resistance resin base material is more suitable for optical elements used in outdoors. Concrete examples include a backseat for a solar battery; base materials of films to be pasted on a window such as a heat ray reflecting film which is pasted on windows of facilities exposed to sunlight for a long time, for example, outdoor windows of building and car windows, so as to provide a heat ray reflecting effect; a reflective board; a light collecting board, a film for a vinyl house for agriculture; and the like.

When the weather resistance resin base material is used as optical elements, it is preferable to coat a adhesive layer to paste the weather resistance resin base material onto a base plate such as a glass plate.

The adhesives layer may be provided on any one of a side of the resin base material where a ceramic layer exists and a side where a ceramic layer does not exist. However, in the case that a ceramic layer is provided only one side of the resin base material, when the resin base material is pasted on a base plate such as a glass plate, it is preferable that a side of the resin base material where a ceramic layer does not exist is pasted on a base plate such as a glass plate. As the adhesive, an adhesive including a light hardening resin or thermo hardening resin as a main component may be employable.

It is preferable for the above-mentioned adhesives to have durability to UV rays, and the adhesives are preferably an acrylic type sticky agent or a silicon type sticky agent. Further, from the viewpoints of sticky properties and cost, an acrylic type sticky agent is preferable. Specifically, from a point that releasing strength can be easily controlled, in the acrylic type sticky agent, among a solvent type and an emulsion type, the solvent type is preferable. In the case of using a solution polymerized polymer as an acrylic solvent type sticky agent, a well-known monomer can be used as its polymer. For example, as a main monomer as a skeleton, acrylic esters, such as ethyl acrylate, butyl acrylate, 2-ethyl hexyl acrylate, and oquryl acrylate, can be exemplified preferably. As a comonomer for increasing coagulation force, vinyl acetate, acrylicnitrile, styrene, methyl methacrylate, etc. can be exemplified preferably. Further, as a functional group containing monomer to advance cross-linking so as to provide a stable sticky force and to maintain the sticky force to a certain extent under the presence of water, methacrylic acid, acrylic acid, itaconic acid, hydroxyethyl methacrylate, glycidyl methacrylate, etc. can be exemplified preferably.

The production of the sticky agent used as an adhesive may be conducted by well-known methods. For example, it can be produced in such a way that predetermined starting materials are put in a reaction chamber under existence of organic solvents, such as ethyl acetate and toluene, and polymerization is caused under heat with the presence of catalyst of peroxide type, such as a benzoyl peroxide, or azobis type, such as azobisisobutyronitrile. In order to increase the molecular weight, for example, it is preferable to employ a method of throwing monomer collectively in the early stage of a reaction, or to use ethyl acetate than toluene which has a large chained-transfer coefficient and suppresses polymer growth. The weight average molecular weight (Mw) of a polymer is preferably 400,000 or more, and more preferably 500,000 or more. When the molecular weight is less than 400,000, even if cross-linking is made with an isocyanate hardening agent, a polymer having a sufficient coagulating force cannot be obtained. Accordingly, in the evaluation of holding power with the application of a weight, dropping occurs instantly, or after when a test piece is peeled off at a predetermined time after the test piece is pasted with a sticky agent on a glass plate, the sticky agent may remain on the glass plate.

As a hardening agent of the sticky agent, specifically in an acrylic solvent type, general hardening agents such as an isocyanate type hardening agent and an epoxy type hardening agent are employable. However, since the flowability of a sticky agent and cross-linking over the passage of time are needed in order to obtain a uniform layer, an isocyanate type hardening agent is preferable.

In the adhesive agent, as additives, for example, a stabilizer, a UV absorber, a flame retarder, an antistatic agent, etc. may be contained. The thickness of the adhesive layer is preferably 5 to 50 μm.

As a coating method of the adhesive agent, optional well-known methods may be employable, for example, a die coater method, a gravure coater method, a blade water method, a spray water method, an air knife coat method, a dip coating method, etc. are employable. Furthermore, before an sticky layer is laminated, if needed, for the purpose of increasing a close contact ability and a coating ability, the surface of film is preferably subjected to physical surface treatment, such as flame treatment, corona discharge treatment, and plasma discharge treatment; and chemical surface treatment, such as easily-adhesive organic or inorganic resin coating.

### EXAMPLE

Hereafter, the present invention will be explained in detail with reference to examples. However, the present invention is not limited to these examples.

### Example

### Production of Sample 1

### Production of Resin Base Material 1

Polymerization was conducted by the use of magnesium acetate, antimony trioxide, and phosphoric acid, whereby Polyester A1 was obtained. This Polyester A1 and 2,2′-(1,4-phenylene) bis-(4H-3,1-benzoxazin-4-one) as an ultraviolet absorber were compounded by a twin screw extruder with a vent such that the content of the ultraviolet absorber became 15 mass %, whereby Polyester A2 containing the ultraviolet absorber was obtained. Polyester A1 and Polyester A2 were prepared such that the content of the ultraviolet absorber became 0.5 mass % to the whole polyester, the prepared polyester was dried at 150° C. in a vacuum for two hours, successively dried at 175° C. in a vacuum for three hours, and then melted and extruded at 278° C. on a casting drum. The extruded film was rapidly cooled and solidified on the casting drum while being applied with electrostatic with a tape-shaped electrode, whereby an unstretched film was obtained. The unstretched film was preheated at 75° C., and then stretched in the longitudinal direction to 3.3 times with a roller heated to 80° C. by the use of a radiation heater, whereby a uniaxially-stretched film was obtained. Thereafter, onto both sides of the uniaxially-stretched film, a coating liquid containing a water dispersible acrylic resin (concentration: 4.0 mass %) and an easy smoothing agent (colloidal silica with a particle size of 0.1 μm, a solid content ratio of 0.35 parts by weight) was coated with a No. 4 metal bar as laminated layers, and then the uniaxially-stretched film with the laminated layers were stretched in the width direction by 3.6 times at 110° C., and subjected to a heat treatment at 220° C., whereby Resin base material 1 (biaxially-stretched and containing a light stabilizer) with a film thickness of 125 as a whole body was obtained.

### <Formation Of Polymer Layer>

On the abovementioned Resin base material 1, a polymer layer coating liquid with the following composition was coated by the use of a micro gravure coater such that the film thickness after hardened became 2 μm. Then, after the solvents were evaporated and the coated layer was dried, the coated layer was hardened by being irradiated with UV rays at 0.2 J/cm² by the use of a high pressure mercury vapor lamp, whereby Polymer layer (polymer film) composed of an acrylic type hardened layer was formed.

### (Polymer Layer Coating Liquid)

| | |
|---|---|
| Dipenta erythritol hexa acrylate monomer | 60 parts by weight |
| Dipenta erythritol hexa acrylate dimer | 20 parts by weight |
| Component more than dipenta erythritol hexa | 20 parts by weight |
| acrylate trimer | |
| Dimethoxy-benzophenone photoreaction initiator | 4 parts by weight |
| Methyl ethyl keton | 75 parts by weight |
| Propylene glycol monomethyl ether | 75 parts by weight |

### <Formation of a Ceramic Layer>

On the abovementioned Polymer layer, Ceramic layer 1 (50 nm, C content: 7.8 at %), Ceramic layer 2 (50 nm, C content: 0.1 at % or less), and Ceramic layer 3 (500 nm, C content: 7.8 at %) were provided on the following conditions, whereby Ceramic layer was formed, and Sample 1 was produced. The refractive index of Ceramic layer was 1.46.

(Production of Ceramic layer 1)<

### <Composition of Mixed Gas for Ceramic Layer 1>

| | |
|---|---|
| Discharge gas: Nitrogen gas | (94.85 volume %) |
| Thin film forming gas: hexamethyl disiloxan | (0.15 volume %) |
| Additive gas: Oxygen gas | (5.0 volume %) |

### <Film Forming Condition for Ceramic Layer 1>

First Electrode Side
Type of a power source: Heiden laboratory 100 kHz (continuous mode) PHF-6k
Frequency: 100 kHz
Power density: 10 W/cm² (voltage Vp at this time was 7 kV)
Electrode temperature: 120° C.

Second Electrode Side
Type of a power source: Pearl industry 13.56 MHz CF-5000-13M
Frequency: 13.56 MHz
Power density: 5 W/cm² (voltage Vp at this time was 1 kV)
Electrode temperature: 90° C.
   (Production of Ceramic layer 2)

### <Composition of Mixed Gas for Ceramic Layer 2>

| | |
|---|---|
| Discharge gas: Nitrogen gas | (94.99 volume %) |
| Thin film forming gas: tetra ethoxy silan | (0.01 volume %) |
| Additive gas: Oxygen gas | (5.0 volume %) |

### <Film Forming Condition for Ceramic Layer 1>

First Electrode Side
Type of a power source: Heiden laboratory 100 kHz (continuous mode) PHF-6k
Frequency: 100 kHz
Power density: 10 W/cm² (voltage Vp at this time was 7 kV)
Electrode temperature: 120° C.

Second Electrode Side
Type of a power source: Pearl industry 13.56 MHz CF-5000-13M
Frequency: 13.56 MHz
Power density: 10 W/cm² (voltage Vp at this time was 2 kV)
Electrode temperature: 90° C.

### (Production of Ceramic Layer 3)

### <Composition of Mixed Gas for Ceramic Layer 3>

| | |
|---|---|
| Discharge gas: Nitrogen gas | (94.5 volume %) |
| Thin film forming gas: hexamethyl disiloxan | (0.5 volume %) |
| Additive gas: Oxygen gas | (5.0 volume %) |

### <Film Forming Condition for Ceramic Layer 3>

First Electrode Side
Type of a power source: Heiden laboratory 100 kHz (continuous mode) PHF-6k
Frequency 100 kHz
Power density: 10 W/cm² (voltage Vp at this time was 7 kV)
Electrode temperature: 120° C.

Second Electrode Side
Type of a power source: Pearl industry 13.56 MHz CF-5000-13M
Frequency: 13.56 MHz
Power density: 5 W/cm² (voltage Vp at this time was 1 kV)
Electrode temperature: 90° C.

### Production of Sample 2

On one side of Resin base material 1 (containing a light stabilizer), the following coating liquid (containing a light stabilizer) was coated by the use of a gravure coater such that a coating amount became 5 g/m² in solid content, and then the coating layer was dried at the condition of a drying temperature of 60° C., whereby a polymer layer was formed. Further, a ceramic layer was formed on this polymer layer in the same way as that in Sample 1, whereby Sample 2 was produced.

### (Preparation of Coating Liquid 1)

Copolymerization was conducted among 65 mass % of methyl-methacrylate and 35 mass % of 2-hydroxyethyl methacrylate, whereby hydroxyl group-introduced methacrylic ester resin with an average molecular weight of 50000 was prepared. For this resin, 5 mass % of 2-(2H-benzotriazol2-yl)-4,6-di-t-pentylphenol (TINUVIN328; manufactured by Chiba Japan) being a benzotriazol-type ultraviolet absorber as an ultraviolet absorber, and 5 mass % of decanedioic acid bis [(2,2,6,6-tetramethyl-1 (octyloxy)-4-piperidinyl)]ester (TINUVIN123; manufactured by Chiba Japan) being a hindered amine type light stabilizer as a light stabilizer were blended, and diluted with methyl ethyl ketone for viscosity control, whereby Main agent (a) having been adjusted a solid content to become 20 mass % was obtained. On the other hand, an adduct type hexamethylene diisocyanate as a polyisocyanate compound becoming a cross linking agent (hardening agent) was adjusted with methyl ethyl ketone such that a solid content became 75 mass %, whereby Hardening agent (b) was obtained.

The above Hardening agent (b) was added to Main agent (a) by 15 mass %, whereby Coating liquid 1 was prepared.

### (Preparation of Coating Liquid 2)

For the polymer layer coating liquid prepared in the above, 5 mass % of 2-(2H-benzotriazol2-yl)-4,6-di-t-pentylphenol (TINUVIN328; manufactured by Chiba Japan) being a benzotriazol-type ultraviolet absorber as an ultraviolet absorber, and 5 mass % of decanedioic acid bis [(2,2,6,6-tetramethyl-1 (octyloxy)-4-piperidinyl)]ester (TINUVIN123; manufactured by Chiba Japan) being a hindered amine type light stabilizer as a light stabilizer were blended, and diluted with methyl ethyl ketone for viscosity control such that the solid content is adjusted to become 20 mass %.

### Production of Sample 3

On one side of a PET (polyethylene terephthalate) film HS manufactured by Teijin DuPont Limited (38 μm in thickness) which does not contain a light stabilizer, the above Coating liquid 1 (containing a UV absorber as a light stabilizer) was coated by a gravure coater such that a coating amount became 5 g/cm² as a solid content, and the resultant coating layer was dried, whereby a polymer layer was formed. The resin base material which formed this polymer layer is “a resin base material containing a light stabilizer”. On this polymer layer, a ceramic layer was provided in the same way as that in Sample 1, whereby Sample 3 was produced.

### Production of Sample 4

In the production of Sample 2, on one side of Resin base material 1 where a polymer layer and a ceramic layer were not provided, Coating liquid 1 was coated and dried and, on the coated layer, a ceramic layer was provided, whereby Sample 4 in which the polymer layer and the ceramic layer were provided on both sides of Resin base material 1 was produced.

In this production, after a ceramic layer was provided on one surface, when another ceramic layer was provided on the opposite surface, a mold releasable resin base material produced by the below-mentioned method was pasted on the low refractive index ceramic layer provided previously, and then the another ceramic layer was provided while the low refractive index ceramic layer was being protected.

### (Production of a Mold Releasable Resin Material)

A silicon type remover was coated on a polyethylene terephthalate film with a thickness of 38 μm. On the surface of the polyethylene terephthalate film where silicon type remover was coated, 100 parts by weight of an acrylic type sticky agent (polymer in which butyl acrylate was made as a main monomer), 6 parts by weight of hexamethylene diisocyanate trimethylolpropane adduct solution with a concentration of 75 mass % (product name: Coronate-HL, a solid content concentration of 75 mass %, manufactured by Nippon polyurethane Industry Co., LTD.) as a cross linking agent, 4 parts by weight of methylated methylolmelamine with a concentration of 20 mass %, and 0.5 parts by weight of dinonyl naphthalene disulfonic acid as a crosslinking catalyst were coated such that a thickness after drying became 5 μm, and the coated layer was dried at 100° C. for three minutes by a drying device so as to form a sticky agent layer. Immediately after that, a polyethylene terephthalate film (base material) was pasted on the sticky agent layer, whereby a mold releasable resin material was produced.

### Production of Sample 5

In the production of Sample 4, on the ceramic layer at one side, a polymer layer was provided by the use of Coating liquid 1, whereby Sample 5 was produced.

### Production of Sample 6

In the production of Sample 3, on the ceramic layer, Coating liquid 2 was coated by the use of a micro gravure coater such that a layer thickness after hardening became 3 μm. After a solvent was evaporated and the coating layer was dried, the coating layer was hardened by being irradiated with UV rays with 0.4 J/cm² by the use of a high pressure mercury vapor lamp so as to form a polymer layer, whereby Sample 6 was produced.

### Production of Sample 7

On one surface of Resin base material 1, Coating liquid 1 was coated by the use of a gravure coater such that a coating amount became 5 g/cm² as a solid content, and the resultant coating layer was dried at 60° C., whereby Sample 7 was produced.

### Production of Sample 8

In the production of Sample 1, Sample 8 was produced in the same way except that Resin material 1 was replaced with a PET (polyethylene terephthalate) film HS with a thickness of 38 μm manufactured by Teijin DuPont Limited which does not contain a light stabilizer.

### Production of Sample 9

In the production of Sample 2, Sample 9 was produced in the same way except that a ceramic layer was formed in the following ways.

### <Formation of a Ceramic Layer>

Resin base material 1 was set in a magnetron sputtering device and a chamber was subjected to vacuuming. Then, into the chamber, a mixed gas in which oxygen gas was added by 7% into Ar gas was introduced such that the pressure in the chamber became 0.25 Pa, and a direct current voltage was applied to a cathode where silicon target was set, so that sputtering was caused and silicon oxide film with a thickness of 100 nm was formed. The refractive index of the resultant ceramic layer was 1.58.

### [Evaluation of Samples]

The following evaluation was conducted for the produced Samples.

### (Moisture Vapor Transmission Rate)

The moisture vapor transmission rate was measured by the use of a moisture vapor transmission rate measuring apparatus PERMATRAN-W3/33MG module manufactured by MOCON Corporation in accordance with the method (40° C., 90% RH) specified in JIS K 7129B.

### (Haze)

An outdoor exposure accelerating test (weather resistance test) was conducted in such a way that Samples were subjected to irradiation for 3000 hours (corresponding to three years with outdoor exposure) by the use of Sunshine weather meter (WEL-SUN-HCL type, manufactured by Suga Test Instruments Co., Ltd.) in accordance with JIS-K-6783b. Haze in the thickness direction was measured for Samples after the weather resistance test by the use of a full automatic direct reading haze computer HGM-2DP (manufactured by Suga Test Instruments Co., Ltd.), and the measurement data were evaluated by the following criterion.

A: Haze was less than 1.0%

B: Haze was less 1.0% or more and less than 3.0%

C: Haze was 3.0% or more.

### (Yellowing)

“L”, “a”, “b” of Samples were measured before and after the abovementioned weather resistance test by the use of a spectrum type color difference meter SE-2000 type (manufactured by Nippon Denshoku Industries Co., Ltd.)) in accordance with a transmission technique by JIS-K-7105, and yellowing was evaluated with “b” by the following criterion.

A: The increase of “b” after the weather resistance test is less than 1.0

B: The increase of “b” after the weather resistance test is 1.0 or more and less than 3.0

C: The increase of “b” after the weather resistance test is 3.0 or more

### (Mechanical Strength)

The mechanical strength of Samples before and after the weather resistance test was measured by the use of a tensile stress measuring apparatus (Zwick 010, manufactured by Ulm Corporation, Germany) in accordance with ISO 527-1-2, and the measurements were evaluated by the following criterion

A: Ratio of the mechanical strength after the weather resistance test to that before the weather resistance test is 80% or more

B: Ratio of the mechanical strength after the weather resistance test to that before the weather resistance test is 60% or more and less than 80%

C: Ratio of the mechanical strength after the weather resistance test to that before the weather resistance test is less than 60%

The results of the evaluation are indicted in Table 1.

TABLE 1

| | Moisture vapor | | | | |
|---|---|---|---|---|---|
| | transmission | | | | |
| Sample | rate | | | Mechanical | |
| No. | (g/m² · day) | Haze | Yellowing | strength | Remarks |
| 1 | <0.01 | A | B | A | Inventive |
| 2 | <0.01 | A | A | A | Inventive |
| 3 | <0.01 | A | B | A | Inventive |
| 4 | <0.01 | A | A | A | Inventive |
| 5 | <0.01 | B | A | A | Inventive |
| 6 | <0.01 | A | B | A | Inventive |
| 7 | 1.00 | B | B | B | Comparative |
| 8 | <0.01 | A | C | C | Comparative |
| 9 | <0.01 | A | B | A | Inventive |

From Table 1, it turns out that Samples according to the present invention which has at least one layer of a ceramic layer composed of an oxide of Si as a main component on at least one side of a resin base material including a light stabilizer and has a moisture vapor transmission rate (by the method in accordance with JIS K7129-1992 B under the condition of 40° C. and 90% RH) of 0.01 or less (g/m²·24 h), are excellent in weather resistance as compared with Comparative examples.

### EXPLANATION OF SYMBOLS

1 Resin Film
2 Ceramic Layer
3 Resin Base Material
4 Light Stabilizer
5 Polymer Layer
10 Plasma Discharge Processing Apparatus
11 First Electrode
12 Second Electrode
21 First Power Source
22 Second Power Source
24 Second Filter
30 Plasma Discharge Processing Apparatus
32 Discharge Space
35 Roll-shaped Rotating Electrode
35a Roll electrode
35A Metal base metal
35B Derivative
36 Square Tube Type Fixed Electrode Group
40 Electric Field Forming Means
41 First Power Source
42 Second Power Source
43 First Filter
44 Second Filter
50 Gas Feeding Means
51 Gas Generating Apparatus
52 Air Feeding Port
53 Exhaust Port
60 Electrode Temperature Regulating Means
G Thin Film Forming Gas
G° Gas in Plasma State
G′ Processing Exhaust Gas
F Resin Base Material

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A weather resistance resin base material, comprising:
a resin base material containing a light stabilizer; and
at least one layer of a ceramic layer including an oxide containing Si or Al, a nitrogen oxide containing Si or Al, or a nitride containing Si or Al, as a main component on at least one side of the resin base material, wherein the weather resistance resin base material has a moisture vapor transmission rate of 0.01 g/(m²·24 h) or less, where the moisture vapor transmission rate is measured by the JIS K7129-1992 B method under a condition of 40° C. and 90% RH.

13. The weather resistance resin base material described in claim 12, wherein the resin base material is a resin of polyethylene terephthalate, polybutylene terephthalate, or polyethylene naphthalate.

14. The weather resistance resin base material described in claim 12, wherein the light stabilizer is an ultraviolet absorber, a hindered amine light stabilizer or a combination of a ultraviolet absorber and a hindered amine light stabilizer.

15. The weather resistance resin base material described in claim 12, wherein the ceramic layer is formed by a thin film forming method which feeds a gas containing a thin film forming gas and a discharge gas in a discharge space under an atmospheric pressure or a pressure in the vicinity of the atmospheric pressure; applies a high frequency electric field in the discharge space so as to excite the gas; and exposes the resin base material to the excited gas so as to form a thin film.

16. The weather resistance resin base material described in claim 15, wherein the discharge gas is a nitrogen gas; a first high frequency electric field and a second high frequency electric field are superimposed in the high frequency electric field applied in the discharge space; a frequency ω2 of the second high frequency electric field is higher than a frequency ω1 of the first high frequency electric field; a relation among an intensity V1 of the first high frequency electric field, an intensity V2 of the second high frequency electric field, and an intensity IV of a discharge starting electric field satisfies a relationship: (V1≧IV>V2 or V1>IV≧V2); and an output density of the second high frequency electric field is 1 W/cm² or more.

17. The weather resistance resin base material described in claim 12, wherein the ceramic layer has a refractive index of 1.3 or more and less than 1.8.

18. The weather resistance resin base material described in claim 12, wherein the ceramic layer comprises at least one layer of a silicon oxide layer having a carbon content less than 0.1 at % and at least one layer of a silicon oxide layer having a carbon content of 1 to 40 at %.

19. The weather resistance resin base material described in claim 12, wherein a polymer layer is provided on at least one side surface of the resin base material and a ceramic layer is provided on the polymer layer.

20. The weather resistance resin base material described in claim 12, wherein a polymer layer is provided on the ceramic layer.

21. The weather resistance resin base material described in claim 19, wherein the polymer layer contains a light stabilizer.

22. An optical member, comprising:
the weather resistance resin base material described in claim 12.
